(19) United States
(12) Patent Application Publication
(10) Pub. No.: US 2026/0289410 A1
(43) Pub. Date: Sep. 24, 2026

(54) SYSTEM

(71) Applicant: SoftBank Group Corp., Tokyo (JP)

(72) Inventor: Naoko NAKANISHI, Tokyo (JP)

(73) Assignee: SoftBank Group Corp., Tokyo (JP)

(21) Appl. No.: 19/568,831

(22) Filed: Mar. 17, 2026

(30) Foreign Application Priority Data
Mar. 19, 2025 (JP) 2025-045176

(51) Int. Cl. G06N 20/00; G06F 40/10; G06F 40/20

(52) U.S. Cl. CPC G06N 20/00; G06F 40/10; G06F 40/20

(57) ABSTRACT

A system includes a processor that is configured to collect corporate information, industry information, business trends, press releases, and news reports from the Internet and databases, and analyze the collected information by using natural language processing techniques, generate, on the basis of the analyzed information, a prompt for instructing a generative AI model to simulate various patterns useful for business decision making, and recognize a user's emotion and select and display information on the basis of the recognized emotion.

### CROSS-REFERENCE TO RELATED APPLICATION

This application is based on and claims priority under 35 USC 119 from Japanese Patent Application No. 2025-045176 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional decision-support systems that collect and analyze corporate and industry information often require users to manually interpret large volumes of data and to manually design analyses and scenarios. As a result, a proposer or decision maker must allocate substantial time to low value-added tasks such as searching, sorting, and preliminary interpretation of information, and cannot sufficiently concentrate on high value-added judgment tasks such as content examination and strategic recommendation. Furthermore, conventional systems typically present information in a static and uniform manner without recognizing the user's emotional state, which leads to mismatches between the information presentation style and the user's cognitive or psychological condition and may reduce the effectiveness and timeliness of decision making. In addition, existing systems are not adequately designed to leverage generative AI models in a structured way, and therefore do not fully utilize generative AI for simulating diverse business decision patterns or for generating incidental, innovation-driving proposals based on big data. Consequently, there is a need for a system that can: automatically collect and analyze business-related information using natural language processing; systematically generate prompts that instruct a generative AI model to simulate various business decision patterns; allow a proposer to focus on high value-added judgment tasks by delegating routine analytical and scenario-generation work to the generative AI model; support a wide range of decision-making contexts including ordering, business alliances, and corporate acquisitions; and recognize a user's emotion so as to select and display information in a manner adapted to the user's emotional state.

### SUMMARY

In order to solve the above problems, a system according to one embodiment comprises a processor configured to collect corporate information, industry information, business trends, press releases, and news reports from the Internet and databases and to analyze the collected information by using natural language processing techniques. The processor is configured to generate, on the basis of the analyzed information, a prompt for instructing a generative AI model to simulate various patterns useful for business decision making. The processor is further configured to recognize a user's emotion and to select and display information on the basis of the recognized emotion. In one aspect, the processor is configured to generate a prompt for instructing the generative AI model to support decision making so that a proposer can concentrate on high value-added judgment tasks including content review and recommendation, by causing the generative AI model to perform tasks such as synthesis of collected information, scenario generation, and proposal drafting. In another aspect, the processor is configured to be usable for various decision makings including ordering, business alliance, and corporate acquisition, and to generate a prompt for instructing the generative AI model to promote innovation by providing incidental proposals through analysis of big data, for example by directing the generative AI model to explore non-obvious correlations, alternative partners, or unexpected business models derived from the analyzed information. Through these configurations, the system enables automated and adaptive support for business decision making, reduces the burden of manual analysis on the proposer, and enhances the quality and innovativeness of decisions while tailoring information presentation to the user's emotional state.

The term “processor” refers to one or more hardware processing units, such as a central processing unit (CPU), graphics processing unit (GPU), or dedicated accelerator, optionally in combination with memory and execution of software instructions, that collectively perform the described functions of collecting, analyzing, generating, recognizing, selecting, and displaying.

The term “corporate information” refers to information relating to a company or organization, including but not limited to its financial data, operational data, organizational structure, products and services, strategies, disclosures, and public announcements.

The term “industry information” refers to information relating to a specific industry or sector, including market size, market structure, key players, competitive conditions, regulations, technological trends, and other macro- and micro-environmental data.

The term “business trends” refers to temporal patterns, movements, or developments in business activities, markets, technologies, regulations, or consumer behavior that influence corporate performance or strategic decisions.

The term “press releases” refers to formal announcements or communications issued by companies, organizations, or institutions to the public or the media, typically describing events such as product launches, financial results, partnerships, or corporate changes.

The term “news reports” refers to articles, bulletins, or broadcasts produced by news agencies, media outlets, or similar information providers that describe events, developments, or analyses relevant to business activities, industries, or markets.

The term “Internet” refers to a global network of interconnected computer networks that use standard communication protocols to enable data exchange between servers, clients, and other devices, and includes publicly accessible web sites, web services, and online data sources.

The term “database” refers to one or more structured data repositories, which may be relational, non-relational, or hybrid, and which store and manage digital records such as corporate data, industry statistics, news items, or historical logs for retrieval and processing by the system.

The term “natural language processing techniques” refers to computational methods and algorithms for processing and analyzing human language data, including but not limited to tokenization, morphological analysis, syntactic parsing, named entity recognition, sentiment analysis, topic modeling, and semantic similarity analysis.

The term “analyzed information” refers to information that has been processed from its original collected form by applying natural language processing techniques and other analytical operations so as to obtain structured data, features, metrics, classifications, or interpretations suitable for subsequent processing.

The term “prompt” refers to a text string, structured message, or other machine-readable instruction that is provided as input to a generative AI model in order to specify a task, a context, constraints, or desired output characteristics, and thereby control the behavior of the generative AI model.

The term “generative AI model” refers to a machine learning model, such as a large language model, multimodal model, or other generative model, that is configured to generate content including text, summaries, scenarios, recommendations, or other outputs in response to a prompt or input data.

The term “simulate various patterns useful for business decision making” refers to causing generation of scenarios, options, strategies, risk-opportunity profiles, or other structured or narrative outputs that represent possible business situations or actions and that are intended to assist users in choosing among alternative decisions.

The term “user's emotion” refers to an affective state of a user, such as happiness, stress, interest, boredom, or similar emotional conditions, which may be inferred from user input, interaction behavior, biometric signals, or other observable indicators.

The term “recognize a user's emotion” refers to detecting or estimating the user's emotional state by processing observable data, such as textual expressions, voice characteristics, physiological measurements, facial expressions, or interaction patterns, using rule-based or machine learning techniques.

The term “select and display information on the basis of the recognized emotion” refers to choosing, prioritizing, or formatting information to be presented to the user, including the level of detail, ordering, emphasis, or visualization style, in accordance with the user's recognized emotional state so as to improve relevance, comprehensibility, or user experience.

The term “proposer” refers to a person, such as a planner, analyst, consultant, or manager, who uses the system to prepare, formulate, or evaluate business proposals, recommendations, or decision options.

The term “high value-added judgment tasks” refers to tasks that require human expertise, insight, or strategic thinking, including but not limited to content examination, evaluation of alternatives, recommendation formulation, and final decision-making, as distinguished from routine data collection or basic analysis.

The term “content review” refers to examination, verification, and qualitative assessment of information, reports, scenarios, or proposals, including checking for consistency, completeness, plausibility, and alignment with business objectives.

The term “recommendation” refers to a suggested course of action, strategy, or decision option presented to a user or organization, which is typically based on analyzed information, simulations, and expert judgment.

The term “ordering” refers to a decision-making context in which a company or organization determines whether, when, and in what quantity to procure products, services, or resources from suppliers or vendors.

The term “business alliance” refers to a cooperative relationship between two or more independent entities, including partnerships, joint ventures, strategic collaborations, or distribution agreements, formed to pursue mutual business objectives.

The term “corporate acquisition” refers to a transaction or series of transactions in which one entity acquires control of another entity, including mergers, share acquisitions, asset purchases, or similar forms of M&A activity.

The term “big data” refers to large-volume, high-velocity, or high-variety datasets, which may include structured, semi-structured, and unstructured data collected from multiple sources such as transaction logs, web content, sensor data, and social media, and that require specialized processing techniques to extract useful information.

The term “incidental proposals” refers to additional, non-obvious, or unrequested ideas, suggestions, or options generated on the basis of analyzed information and big data, which may supplement or extend initial decision options and may lead to unexpected or innovative directions.

The term “promote innovation” refers to facilitating the generation, identification, or adoption of new ideas, business models, strategies, products, or processes that significantly differ from existing practices and that may create competitive advantage or new value.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

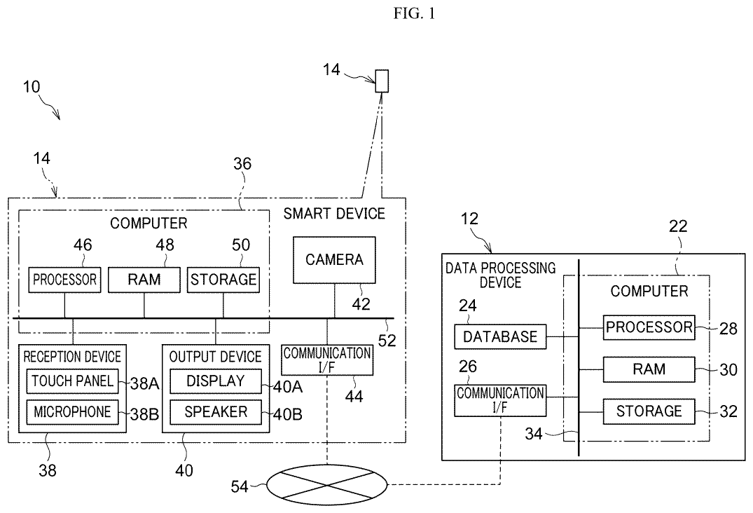

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

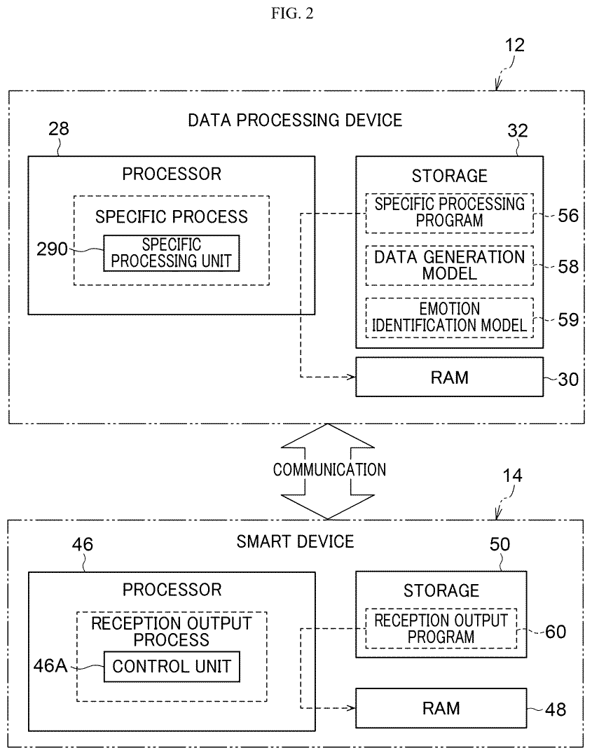

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In many conventional decision-support systems that utilize data analysis and automatic report generation, the computer is used merely as a container for executing independent tools such as web crawlers, analytics engines, and document editors. In such systems, the overall workflow from acquisition of external information, through natural language analysis and predictive simulation, to generation of narrative reports remains fragmented and is orchestrated manually or by static scripts that are insensitive to the semantics of the data and the intent of the user. As a result, the system tends to perform redundant data processing, generate low-relevance analyses, and produce generic or inconsistent output documents that require substantial human post-editing.

Moreover, conventional systems that employ generative models in business contexts typically construct prompts in an ad-hoc manner, without systematic integration of structured simulation results, evaluation indicators, and user-specific requirements. The prompt construction is often hard-coded or template-based and does not adapt to the content or structure of the underlying analysis data. This leads to suboptimal conditioning of the generative model, reduces the reliability and traceability of generated text, and makes it difficult for the system to scale to different application domains or to support fine-grained scenario-based forecasting.

Furthermore, existing reporting systems rarely exploit a closed-loop interaction between machine learning simulations and natural language generation. Simulation modules may output numeric forecasts or time-series data, while report-generation modules simply summarize raw statistics or pre-defined charts. The computer-implemented pipeline does not dynamically select or combine scenarios, nor does it automatically configure the generative model to produce explanations that are aligned with the user's current decision context, the user's state, or the most informative parts of the simulation results. This separation leads to inefficient utilization of computational resources, delays in decision making, and limited transparency, because the human operator must manually interpret heterogeneous outputs. Additionally, many systems lack mechanisms to structure large-scale external data and internal analysis outputs into coherent feature sets and time-series indicators that are directly consumable by both predictive models and generative models. Unstructured use of big data and unstandardized feature engineering increase the computational burden, reduce the reproducibility of analysis, and make it difficult to trace outputs back to specific inputs and processing steps, which is critical for auditability and compliance in enterprise environments. Accordingly, there is a need for an improved computer-implemented system and processing architecture in which a processor centrally orchestrates: (i) acquisition and structuring of external information; (ii) multi-stage natural language analysis; (iii) feature generation and scenario-based simulation using statistical learning or machine learning models; and (iv) automatic construction of prompt data that embeds simulation result data into a prompt sentence for a generative model. There is a further need for a system that allows the processor to automatically select and provide appropriate report data or presentation data to a terminal device in accordance with user request content and user state information. Such a system should improve the technical performance of the overall pipeline by reducing manual orchestration, increasing relevance and consistency of generated outputs, and enhancing the efficiency and reliability of machine utilization in large-scale decision-support workflows.

The specific processing by the specific processing unit 290 of the data processing device 12 in Example 1 is realized by the following means.

The present invention provides a server comprising a processor configured to acquire information regarding events from external information sources via a network and store the acquired information as structured data; perform language analysis processing including morphological analysis, part-of-speech tagging, emotion estimation, and topic classification on natural language data included in the structured data, and accumulate analysis results as analysis data; generate time-series indicators and feature quantities from the analysis data, use a statistical learning model or a machine learning model to perform prediction processing or classification processing based on the feature quantities to calculate a plurality of scenarios regarding future events, and generate simulation result data including predicted values and evaluation indicators corresponding to the respective scenarios; generate a prompt sentence, based on the simulation result data and condition information associated with the simulation result data, the prompt sentence defining an objective, an output format, an explanation structure, and elements to be emphasized, and configure prompt data for input to a generative AI model by adding the simulation result data to the prompt sentence; input the prompt data to the generative AI model to cause the generative AI model to generate an explanatory text in natural language, and convert the explanatory text into output format data as report data or presentation data and store the output format data; and select, in accordance with a request content and a state information of a user received from a terminal device, report data or presentation data to be displayed from among the output format data, and provide the selected report data or presentation data to the terminal device. This enables an integrated and technically improved processing pipeline in which the server automatically transforms heterogeneous external information into structured analysis data, derives scenario-based simulations using learning models, and constructs semantically rich, data-grounded prompt data for a generative model, thereby reducing manual orchestration, increasing the relevance and consistency of generated narrative outputs, and enhancing the efficiency, scalability, and transparency of computer-implemented decision-support operations.

The term “processor” refers to one or more hardware processing units, such as a central processing unit or a graphics processing unit, and associated control circuitry configured to execute machine-readable instructions.

The term “external information source” refers to any data-providing system or storage accessible via a communication network, including but not limited to web servers, application servers, online databases, or data feeds.

The term “network” refers to a communication infrastructure that enables electronic data exchange between the server and external information sources or terminal devices, including local area networks, wide area networks, and public packet-switched networks.

The term “structured data” refers to data organized according to a predetermined schema or format, such as records, fields, and data types, enabling systematic storage, retrieval, and processing by a computer system.

The term “natural language data” refers to text or symbolic sequences expressed in a human language and represented in a machine-readable form suitable for computational analysis.

The term “language analysis processing” refers to computer-implemented operations that analyze natural language data, including but not limited to tokenization, morphological analysis, part-of-speech tagging, emotion estimation, and topic classification.

The term “morphological analysis” refers to a process that decomposes natural language text into minimal meaningful units and identifies grammatical attributes such as base forms and inflectional features.

The term “part-of-speech tagging” refers to a process that assigns grammatical category labels, such as noun, verb, adjective, or adverb, to tokens in natural language data.

The term “emotion estimation” refers to a computational process that infers an emotional state or affective polarity, such as positive, negative, or neutral, from natural language data.

The term “topic classification” refers to a computational process that assigns one or more thematic categories to natural language data based on its content.

The term “analysis data” refers to data generated as a result of language analysis processing, including extracted attributes, labels, scores, and any derived information used for subsequent analytical steps.

The term “time-series indicator” refers to a numerical or categorical measure associated with discrete time points or intervals, derived from analysis data to represent temporal patterns or trends.

The term “feature quantity” refers to a numerical value or vector that encodes properties of analysis data, suitable for input to a statistical learning model or a machine learning model.

The term “statistical learning model” refers to a computational model based on statistical principles that uses feature quantities to perform tasks such as prediction, classification, or clustering.

The term “machine learning model” refers to a computational model that learns patterns from data, including but not limited to regression models, classification models, neural networks, and time-series models.

The term “scenario” refers to a hypothetical or projected condition defining a combination of premise parameters under which a statistical learning model or a machine learning model produces forecast or classification results.

The term “simulation result data” refers to data representing outputs of prediction processing or classification processing performed by a statistical learning model or a machine learning model for one or more scenarios, including predicted values and evaluation indicators.

The term “predicted value” refers to an estimated numerical or categorical output produced by a statistical learning model or a machine learning model for a given input feature quantity and scenario.

The term “evaluation indicator” refers to a metric or measure associated with simulation result data that characterizes quality, reliability, or significance of the predicted values, such as accuracy, confidence interval, or risk score.

The term “condition information” refers to information specifying constraints, parameters, or context related to simulation result data, including premise conditions of scenarios, target domains, and output requirements.

The term “prompt sentence” refers to a text instruction in natural language that specifies an objective, an output format, an explanation structure, and elements to be emphasized, and that is provided as conditioning input to a generative AI model.

The term “prompt data” refers to data provided to a generative AI model that includes at least a prompt sentence and associated simulation result data or related structured information.

The term “generative AI model” refers to a computational model configured to generate new data, such as natural language text, conditioned on input data including prompt data.

The term “explanatory text” refers to natural language text generated by a generative AI model that explains, interprets, or describes simulation result data, scenarios, or related analysis results.

The term “output format data” refers to data representing the explanatory text arranged in a form suitable for presentation, including document-like report data or slide-like presentation data.

The term “report data” refers to output format data structured as a continuous or sectioned document intended to convey analysis and simulation results in a report-style format.

The term “presentation data” refers to output format data structured as a sequence of presentation units, such as slides or pages, suitable for visual display in a presentation environment.

The term “terminal device” refers to an information processing apparatus operated by a user, such as a personal computer, a tablet device, or a mobile communication device, capable of communicating with the server.

The term “request content” refers to information indicating a requirement or intent of a user, including at least one natural language instruction or parameter set specifying a desired analysis or output.

The term “state information of a user” refers to information indicating a status or condition associated with a user, such as role, preference, interaction history, or contextual attributes used to control selection or presentation of output format data.

In one embodiment, a server includes a processor, a main memory, a persistent storage device, and a network interface, all connected via a system bus. The server executes a program stored in the persistent storage device and loaded into the main memory. The program causes the processor to cooperate with an operating system, such as a general-purpose server operating system, and application libraries, such as web communication libraries, text processing libraries, and machine learning libraries, to implement the functions described below.

The server uses the network interface to communicate with one or more terminal devices operated by users and with external information sources. The terminal is, for example, a personal computer, a tablet, or a smartphone including a display, an input interface such as a keyboard or touch panel, a local processor, and a communication module. The user operates the terminal by entering natural language instructions, selecting options on a graphical user interface, and viewing generated report data or presentation data.

The server acquires information regarding events from external information sources via the network. The server uses a communication software stack that may include a hypertext transfer protocol client module to send requests to web servers and application programming interfaces of external databases. The server applies a content retrieval module that parses responses and stores acquired data as structured data. For example, the server converts heterogeneous incoming data into records having fields such as a source identifier, a timestamp, a textual field representing natural language content, and additional metadata fields for type and region. These records are stored in a database management system, such as a relational database or a document-oriented database, in dedicated tables or collections.

The server performs language analysis processing on the natural language data included in the structured data. The server uses a natural language analysis library to perform tokenization and morphological analysis, generating sequences of tokens and associated attributes. The server further applies a part-of-speech tagging model, which can be implemented as a conditional random field or a recurrent neural network, to assign grammatical categories to tokens. The server uses an emotion estimation module, which may be based on a classifier that takes as input token embeddings or sentence embeddings and outputs an affective label or a continuous sentiment score. The server additionally executes a topic classification model, such as a supervised text classifier trained using a linear model or a neural network, to assign one or more topic labels to each text instance.

The server stores analysis results as analysis data. The analysis data includes, for each text instance, a token list, a list of part-of-speech tags, an emotion score, and one or more topic identifiers. The server aggregates this information into data structures that are stored in the database, such as analysis tables linked to the original structured data by identifiers. By storing token-level and document-level attributes separately, the server improves data locality and query performance, which reduces memory usage and accelerates downstream feature generation.

The server generates time-series indicators and feature quantities from the analysis data. The server groups analysis records according to time intervals, such as days or weeks, and computes aggregate values such as counts of occurrences of a given topic, average emotion scores, and frequencies of specific terms or entities. The server encodes these aggregates in arrays or matrices, where each row corresponds to a time interval and each column corresponds to a particular indicator. The server creates feature quantities by transforming these indicators using normalization, scaling, or dimensionality reduction techniques. For example, the server may compute log-transformed counts or principal component scores to reduce noise and redundancy. The resulting feature quantities are stored in a feature repository in the database, enabling reuse across multiple simulations and minimizing repeated computation.

The server uses a statistical learning model or a machine learning model to perform prediction processing or classification processing based on the feature quantities. In one embodiment, the server uses a regression model, such as a linear regression or a gradient-boosted decision tree, to predict continuous variables representing future indicator values. In another embodiment, the server uses a classification model, such as a logistic regression or a random forest, to assign probability distributions over discrete outcome categories. In yet another embodiment, the server uses a neural network, such as a multi-layer perceptron or a recurrent neural network with long short-term memory units, to capture nonlinear temporal dependencies in the time-series indicators.

The server trains or fine-tunes the machine learning models using training data stored in the feature repository and corresponding target values that may be derived from historical records. The server defines a loss function, such as mean squared error for regression or cross-entropy for classification, and iteratively updates model parameters using an optimization algorithm such as stochastic gradient descent or adaptive moment estimation.

The server may perform early stopping based on validation loss, and may use regularization techniques to avoid overfitting. By performing training and fine-tuning on the server, the system can adapt to changes in external information and maintain high prediction accuracy.

The server calculates a plurality of scenarios regarding future events using the trained models. The server defines scenarios by varying a set of premise conditions, such as external indicators, assumed intervention levels, or exogenous variables. For each scenario, the server modifies corresponding components of the feature quantities and executes inference with the trained model to obtain predicted values. The server also computes evaluation indicators, such as confidence intervals derived from model uncertainty estimates, performance metrics from back-testing, or risk scores based on sensitivity analysis. The server stores the results as simulation result data, including, for each scenario, the predicted values, evaluation indicators, and a representation of the premise conditions. The explicit storage of scenario definitions and associated outputs allows the server to trace decisions back to underlying assumptions and model behavior, which improves auditability.

The server generates a prompt sentence for a generative AI model based on the simulation result data and condition information associated with the simulation result data. The server maintains templates or template fragments that define an objective, an output format, an explanation structure, and elements to be emphasized. The server composes the prompt sentence by inserting scenario descriptions, predicted values, evaluation indicators, and relevant context into the templates. The server also incorporates user-specific condition information, such as target audience, desired level of technical detail, and focus areas, which may be provided by the terminal and stored with the job context. The prompt sentence thus becomes a structured, semantically rich instruction that encodes the content and structure of the desired explanatory text.

The server configures prompt data for input to the generative AI model by adding the simulation result data to the prompt sentence. In one embodiment, the server appends a machine-readable summary of the simulation results, such as key-value pairs or bullet lists, to the prompt sentence. In another embodiment, the server embeds numerical values within the narrative part of the prompt, using standardized phrases that signal to the generative model the significance and relationships among the values. This combined prompt data reduces ambiguity and provides the generative model with explicit, context-aware constraints, which leads to more accurate and consistent text generation compared to ad-hoc prompts.

The server inputs the prompt data to the generative AI model. The generative AI model can be implemented as a neural language model, such as a transformer-based architecture having multiple encoder-decoder layers, attention mechanisms, and positional encodings. The server supplies the prompt data as tokenized input and configures generation parameters, such as the maximum number of tokens to generate, a sampling temperature, and top-k or nucleus sampling thresholds. The generative AI model produces an explanatory text in natural language that describes the simulation result data, explains the significance of scenarios, and provides structured narrative content according to the requested explanation structure.

The server converts the explanatory text into output format data as report data or presentation data. The server uses a document formatting module to segment the explanatory text into sections with headings, paragraphs, and lists, according to the explanation structure specified in the prompt sentence. In one embodiment, the server generates report data by rendering the text into a paginated document format, such as a portable document format, using a document composition engine. In another embodiment, the server generates presentation data by dividing the text into slide-sized units and arranging titles and bullet points in a presentation file format. The server stores the output format data in a file storage system and records metadata, including links between the output format data and the underlying simulation result data, which facilitates traceability and reuse.

The terminal receives, from the server, information indicating availability of new report data or presentation data. The terminal requests the desired data and displays it to the user using a viewer application. The user reads the explanatory text and may provide feedback or updated instructions. The user may, for example, request a revised report that emphasizes regulatory risks and provides a more conservative forecast scenario. The terminal transmits this updated request content to the server.

The server selects, in accordance with the request content and state information of the user, report data or presentation data to be displayed from among the stored output format data and provides the selected data to the terminal. The state information can include user roles, such as analyst or executive, and preferences, such as desired level of detail or preferred visualization type. The server applies selection rules that map user states and request content to suitable document versions. For example, the server may choose a more condensed presentation data for an executive user and a more detailed report data for an analyst user.

This adaptive selection reduces unnecessary data transfer and processing, thereby improving communication efficiency and user experience.

In one concrete example, the user is considering the introduction of a new product in a particular regional market. The user operates the terminal to input a natural language instruction, such as:

“Analyze the growth forecast of the electric vehicle market in the next quarter and create a report that considers major competitors' strategies.”

The terminal transmits this instruction and additional parameters, such as target region and time horizon, to the server. The server acquires relevant external information, performs the described language analysis processing, generates time-series indicators, and executes a neural network time-series forecasting model. The server then constructs a prompt sentence such as:

“The user has requested the following: ‘Analyze the growth forecast of the electric vehicle market in the next quarter and create a report that considers major competitors’ strategies.′ Using the simulation results below, generate a formal business report in English. Include: 1. Executive summary, 2. Market background, 3. Forecast scenarios (base, optimistic, pessimistic), 4. Competitor strategy comparison, 5. Strategic recommendations for a new market entrant. Simulation data (aggregated): Region: North America, Forecast horizon: next quarter, Base scenario growth rate: 12% (confidence interval: 8-16%), Optimistic scenario growth rate: 18% (confidence interval: 14-22%), Pessimistic scenario growth rate: 6% (confidence interval: 2-10%), Main competitors: [list of competitors], Key drivers: government incentives, infrastructure expansion, cost reduction. Write the report as continuous prose with clear headings and bullet lists where appropriate.” The server embeds the numeric values and scenario labels into the prompt data and submits it to the generative AI model. The generated explanatory text is then formatted into both report data and presentation data, which are stored and made available to the terminal.

This configuration improves computer technology itself rather than merely automating human tasks. The server implements specific data structures for structured data, analysis data, feature quantities, and simulation result data, enabling efficient indexing, retrieval, and reuse that are not practical with manual handling. The integration of language analysis processing and time-series feature generation allows the server to construct feature quantities that capture both semantic and temporal aspects of external information, improving prediction accuracy and robustness of the models.

By generating prompt data that systematically embeds simulation result data and condition information, the server reduces ambiguity and variance in generative outputs, thereby increasing consistency and reducing post-editing overhead. The explicit linkage between simulation result data, prompt data, and generated explanatory text enables traceability and error analysis, which is not achievable when generative models are used with unstructured prompts.

The server also reduces communication load between the server and the terminal by selecting appropriate report data or presentation data based on user state information, avoiding the transfer of unnecessary large documents. Additionally, by storing intermediate data structures and reusing them across multiple user requests, the server reduces redundant computation, improving overall processing speed and resource utilization.

In alternative embodiments, the server may use different model architectures for language analysis, such as convolutional neural networks or transformer-based text classifiers, or may integrate multiple models in an ensemble. The server may also employ different optimization algorithms, loss functions, or regularization techniques depending on the characteristics of the data and the desired performance. The generative AI model may be deployed on dedicated accelerator hardware to further increase throughput and reduce latency.

In yet another embodiment, the server may apply rule-based filters in combination with machine learning outputs, for example, by using explicit rules to prioritize certain scenarios or to enforce domain-specific constraints when constructing the prompt sentence. These rule-based components provide additional control and interpretability and can be tuned to specific application domains.

Accordingly, the described system provides not only an automated workflow for handling external information and generating reports, but also a technically improved architecture for integrating language analysis, machine learning simulation, and generative text production in a way that enhances accuracy, efficiency, scalability, and transparency of computer-implemented decision-support processing.

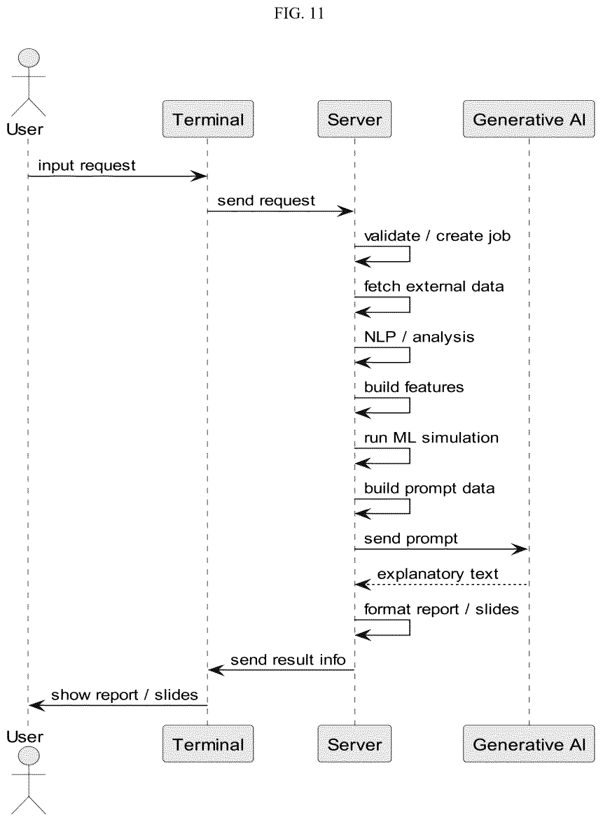

The following describes the processing flow using FIG. 11.

### Step 1:

The user operates the terminal to input a request.

The user enters a natural language instruction (for example, a desired analysis theme and reporting style), and optionally selects parameters such as target domain, region, and forecast horizon. As input, the terminal receives key phrases, text fields, and option selections from the user interface. The terminal encapsulates these elements into a structured request message and outputs the request message to the server via a network connection.

### Step 2:

The terminal transmits the request message to the server.

The terminal uses a communication module to send an HTTP request or a similar protocol message containing the user's natural language instruction and associated parameters. As input, the terminal uses the structured request message created in Step 1. The terminal performs data serialization and attaches authentication information, then outputs the serialized request to the server's network address.

### Step 3:

The server receives and validates the request.

The server uses a network interface and request handler module to accept the incoming message. As input, the server receives the serialized request containing the natural language instruction, parameters, and user identification data. The server parses the message, checks required fields, verifies data types, and validates access rights. Based on this validation, the server outputs a normalized job descriptor that includes a job identifier, the user's instruction text, analysis parameters, and initial status information, storing the job descriptor in a database.

### Step 4:

The server acquires external information and constructs structured data.

The server uses a data acquisition module to send queries to external information sources. As input, the server uses the job descriptor from Step 3, including keywords, target time range, and domain constraints. The server issues network requests, receives responses such as documents or records, and parses the responses using parsing routines. The server then performs data extraction and normalization to transform heterogeneous responses into a standardized record format with fields for source information, timestamps, and natural language content. The server outputs a collection of structured records and stores them in a structured data repository associated with the job identifier.

### Step 5:

The server performs language analysis processing.

The server applies a language analysis module to the natural language content in the structured records. As input, the server uses the structured records from Step 4, including text fields and metadata. The server executes tokenization, morphological analysis, and part-of-speech tagging to assign grammatical information to each token. The server then performs emotion estimation to compute sentiment or affective scores, and topic classification to assign one or more thematic categories to each text segment. The server aggregates these results into analysis records, and outputs analysis data containing token-level attributes, document-level labels, emotion scores, and topic identifiers, which the server writes to an analysis data repository.

### Step 6:

The server generates time-series indicators and feature quantities.

The server uses a feature generation module to convert analysis data into numerical representations. As input, the server uses the analysis data from Step 5, including timestamps, topic labels, and emotion scores. The server groups analysis records by predefined time intervals and computes aggregate indicators such as counts per topic, average sentiment values, and frequency statistics for key terms. The server then transforms these indicators into normalized feature vectors using scaling, encoding, or dimensionality reduction operations. The server outputs time-series feature matrices, where each matrix row corresponds to a time interval and each column corresponds to a specific feature quantity, and stores the matrices in a feature repository linked to the job identifier.

### Step 7:

The server performs scenario-based simulation using learning models.

The server invokes a model execution module to perform prediction or classification. As input, the server uses the feature matrices from Step 6 and stored model parameters for statistical learning models or machine learning models. The server first selects baseline feature segments as historical context, then constructs modified feature sets for multiple scenarios by adjusting selected features according to premise conditions defined by the job descriptor or internal rules. The server applies the models to these feature sets, executing prediction or classification operations to compute predicted values for each scenario. The server also calculates evaluation indicators such as error estimates, confidence measures, or sensitivity scores from model outputs and internal validation data. The server outputs simulation result data that includes, for each scenario, the premise conditions, predicted values, and evaluation indicators, and stores the simulation result data in a simulation repository.

### Step 8:

The server constructs a prompt sentence and prompt data for a generative AI model. The server uses a prompt construction module to generate an instruction text. As input, the server uses the simulation result data from Step 7 and condition information, including user-specified objectives, output format requirements, and explanation structure preferences, from the job descriptor. The server selects relevant scenarios, extracts key predicted values and evaluation indicators, and inserts them into a prompt template that defines sections such as executive summary and scenario comparison. The server then appends or embeds a structured summary of the simulation result data within or following the natural language portion of the prompt. As output, the server produces a prompt sentence and associated structured elements combined as prompt data, and stores this prompt data in a prompt repository.

### Step 9:

The server generates explanatory text using the generative AI model.

The server invokes a generative model interface module. As input, the server uses the prompt data from Step 8, including the prompt sentence and embedded simulation information. The server encodes the prompt data into tokens compatible with the generative model and sets generation parameters such as maximum length and sampling configuration. The generative AI model processes the tokenized prompt and outputs a sequence of tokens representing a coherent explanatory text that reflects the specified scenarios, predicted values, and explanation structure. The server decodes the tokens back into natural language strings. The server outputs the generated explanatory text and writes it to a storage component associated with the job identifier.

### Step 10:

The server formats the explanatory text into report data and presentation data.

The server uses a formatting module to transform raw text into presentation-ready structures. As input, the server uses the explanatory text from Step 9 and layout rules corresponding to report and presentation formats. The server analyzes the text to identify headings, paragraphs, and list items according to markers included in the prompt or generated content. The server segments and structures the content into a document layout for report data and into slide-like units for presentation data. The server may attach references to underlying scenarios and predicted values as metadata. As output, the server generates output format data, including a report representation and a presentation representation, and stores them in an output repository together with their metadata.

### Step 11:

The server selects appropriate output format data based on user context.

The server uses a selection module to determine which output to provide. As input, the server uses the output format data from Step 10, the job descriptor from Step 3, and state information of the user, such as role or preference, which may be updated from previous interactions. The server evaluates selection rules that map user state and request content to one or more document types and levels of detail. The server filters and ranks candidate report data and presentation data according to these rules. As output, the server produces selection information including identifiers or locations of chosen documents and prepares a response structure containing links or references to the selected data.

### Step 12:

The server transmits selected output data to the terminal.

The server composes a response message containing the selection information and, as needed, the corresponding report or presentation content or links. As input, the server uses the selection information from Step 11 and the stored output format data. The server serializes the content or references and sends the response message to the terminal through the network interface. The server outputs a completed transmission event and may update access logs indicating that the specified user has been provided with the selected data.

### Step 13:

The terminal receives and presents the selected data to the user.

The terminal uses a communication module to receive the response from the server. As input, the terminal obtains the response message containing references to, or payloads of, report data and presentation data. The terminal parses the response, retrieves the corresponding content if necessary, and opens a viewer application to render the report or presentation on the display. The terminal outputs a visual representation of the explanatory text and associated structures, enabling the user to read and interpret the machine-generated results.

### Step 14:

The user reviews the generated content and optionally refines the request.

The user observes the displayed report data or presentation data on the terminal. As input, the user receives the visual content generated in Step 13. The user assesses whether the explanations, scenarios, and focus areas satisfy the user's needs, and may then enter updated instructions, such as a refined natural language request to emphasize specific risks or adjust forecast assumptions. The user thus outputs new input conditions to the terminal, which can trigger a new execution of the preceding steps with modified parameters.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented decision support systems for advertising planning are typically configured as static data dashboards or rule-based recommendation engines. Such systems suffer from multiple technical limitations in terms of how they acquire, transform, and utilize large-scale, heterogeneous information on organizations, industries, economic tendencies, and competitor activities.

First, known systems generally ingest external information as unstructured text and either store it as-is or apply only coarse statistical aggregation. As a result, processors in such systems are not configured to generate machine-usable feature data that captures temporal transitions of topics and behaviors of competitive entities. This leads to inefficient use of computing resources, because later analytic operations repeatedly re-parse and re-interpret raw text, and prediction models cannot directly consume structured, time-aware features. Second, conventional systems do not tightly integrate feature generation with automated construction of prompt sentences for generative artificial intelligence models. In many existing architectures, prompts are manually crafted or based on simplistic templates, independent of the underlying feature extraction pipeline. This separation prevents the processor from programmatically generating rich, context-sensitive prompts that systematically encode temporal trends, competitor actions, and constraint conditions. Consequently, the interaction between the decision-support engine and the generative AI model becomes ad hoc, non-repeatable, and difficult to scale or optimize.

Third, existing systems often treat outputs of generative AI models as unstructured narrative text that must be manually reviewed and re-entered into other systems. They generally lack processor-level mechanisms to normalize generated proposals into structured data, to evaluate such proposals with predictive models, and to perform prioritization in a consistent and computationally efficient manner. This results in fragmented processing pipelines, redundant computation, and an increased risk of inconsistent recommendations.

Fourth, prior art systems provide only limited support for interactive refinement of advertising plans in a way that is natively integrated with the underlying analytics and prediction engine. Changes made by users on client devices are often handled as superficial edits without triggering a systematic re-evaluation of all relevant metrics, or are processed in a batch manner that does not support near real-time feedback. This restricts the system's ability to adapt to evolving input conditions and degrades the responsiveness of the decision-support process.

Fifth, known systems typically generate reports as static documents or pages, where temporal transitions, competitor features, and recommended plans are presented without a unified, automatically generated explanatory text. This increases cognitive load on the user and forces manual interpretation and summarization, thereby preventing the underlying computer system from optimally supporting high-value judgment tasks and leading to inefficient utilization of computational summarization capabilities.

Accordingly, there is a need for a computer system and processor configuration that (i) automatically collects and preprocesses heterogeneous external information into feature data including temporal transitions and competitor features, (ii) programmatically generates prompt sentences for a generative AI model based on such feature data, (iii) normalizes generative AI outputs into structured representations and evaluates them using statistical learning models, (iv) performs dynamic prioritization and re-evaluation of advertising activity plans in response to user-driven changes from external terminals, and (v) automatically constructs report materials including visualization data and explanatory text. Such a configuration would improve the technical operation of the computer system itself by enabling more efficient data flows, more effective use of machine learning resources, and more responsive, interactive decision support in advertising optimization scenarios.

The specific processing by the specific processing unit 290 of the data processing device 12 in Application Example 1 is realized by the following means.

The present invention provides a server comprising a processor and a memory storing instructions which, when executed by the processor, cause the processor to obtain, via a communication network and an information storage device, information related to organizations and industrial fields, information related to economic tendencies, publicly disclosed information, and news information; to perform preprocessing on the obtained information by using character-information processing technology so as to generate feature data, calculate temporal transitions for extracted terms and topics, and extract features related to actions of competitive entities; to generate a prompt sentence, on the basis of the feature data, the temporal transitions, and the features related to the actions of the competitive entities, for instructing a generative AI model to create a plurality of proposal plans related to advertising activities, acquire the plurality of proposal plans related to the advertising activities from the generative AI model, and store the plurality of proposal plans as structured data; to input information included in the structured data, the information including media categories, target groups, appeal contents, and expenditure amounts, into a statistical learning model, predict index values for each of the plurality of proposal plans, evaluate the plurality of proposal plans under predetermined constraint conditions, and specify prioritized advertising activity plans; to generate visualization data for figure generation by using as input the temporal transitions, the index values, and the prioritized advertising activity plans, create report materials including the visualization data and an automatically generated explanatory text summarizing the temporal transitions, the features related to the actions of the competitive entities, and the prioritized advertising activity plans, and transmit the report materials to an external terminal; and to re-execute the evaluation and the prioritization on the basis of change contents of the advertising activity plans received from the external terminal, update results of the evaluation and the prioritization, and present the updated results to the external terminal. This enables the computer system to internally transform heterogeneous text information into structured, time-aware feature data, to automatically generate and consume prompt sentences for a generative AI model in a closed-loop workflow, to normalize and evaluate generated advertising proposals with predictive models, and to provide dynamically updated, explanatory report materials to client devices, thereby improving the efficiency, scalability, and responsiveness of computer-implemented decision support for advertising optimization.

The term “processor” refers to a hardware-implemented data processing unit, such as a central processing unit or other execution circuitry, configured to execute instructions stored in a memory to perform operations described in this specification.

The term “communication network” refers to a wired or wireless data communication infrastructure, including the Internet, local area networks, wide area networks, or mobile communication networks, that allows the server to send and receive digital information.

The term “information storage device” refers to a hardware storage component, such as a magnetic disk, solid-state drive, optical disk, or network-attached storage, used to store digital data including external information, feature data, structured data, and report materials.

The term “information related to organizations and industrial fields” refers to digital data describing properties, activities, or conditions of business entities and sectors, including corporate profiles, industry analyses, market reports, and similar business-oriented content.

The term “information related to economic tendencies” refers to digital data indicating macroeconomic or microeconomic trends, such as indices, statistics, forecasts, and descriptive text explaining changes in economic conditions over time.

The term “publicly disclosed information” refers to digital data that has been made publicly available through formal or informal publication channels, such as official announcements, regulatory filings, public statements, and other openly accessible documents.

The term “news information” refers to digital data provided by news sources, including articles, reports, and bulletins distributed via online media, broadcast media, or other news dissemination platforms.

The term “character-information processing technology” refers to software-based procedures and algorithms that operate on textual data, including preprocessing, tokenization, normalization, feature extraction, and similar operations on character strings.

The term “feature data” refers to machine-usable representations of input information, including numerical or categorical values derived from text, that capture properties such as term frequencies, topic assignments, competitor indicators, and temporal metrics.

The term “temporal transitions” refers to changes over time in values derived from the information, including variations in frequencies of terms, topics, or events, expressed as time-series data or time-indexed indicators.

The term “terms and topics” refers to textual units and semantic groupings extracted from text data, where “terms” include words or phrases and “topics” include clusters or categories representing thematically related content.

The term “features related to actions of competitive entities” refers to data elements indicating behaviors or events associated with competitors, such as product launches, pricing changes, promotional activities, or media campaigns, extracted from external information.

The term “generative AI model” refers to a machine learning model configured to generate output content, such as text describing proposal plans, in response to an input prompt, and including, for example, neural network-based language models.

The term “prompt sentence” refers to an input text sequence provided to the generative AI model that describes instructions, context, or constraints for generating output content, including proposal plans related to advertising activities.

The term “proposal plan related to advertising activities” refers to a candidate configuration of advertising operations, including target audience, message content, media usage, budget allocation, and scheduling, generated for consideration in campaign planning.

The term “structured data” refers to data organized according to a predefined schema, such as records with named fields, enabling deterministic access, evaluation, and storage by the processor.

The term “media categories” refers to classifications of communication channels used for advertising, including categories such as online display, search, social media, television, radio, print, or other delivery media.

The term “target groups” refers to defined segments of intended recipients of advertising, characterized by attributes such as demographics, interests, location, or behavior.

The term “appeal contents” refers to the substantive elements of advertising messages, including themes, value propositions, slogans, calls to action, and other expressive content designed to influence the target groups.

The term “expenditure amounts” refers to quantitative values indicating resource allocation to advertising activities, such as monetary budgets, bid values, or spending caps for media placements.

The term “statistical learning model” refers to a computational model that uses statistical or machine learning techniques, such as regression, classification, or ensemble methods, to predict output variables from input features.

The term “index values” refers to numerical indicators predicted or calculated for proposal plans, including metrics such as click-through rate, conversion rate, return on investment, or other performance scores.

The term “predetermined constraint conditions” refers to predefined rules, limits, or optimization criteria, such as budget caps, time constraints, or target performance thresholds, used to evaluate and filter proposal plans.

The term “prioritized advertising activity plans” refers to advertising proposal plans that have been ranked or ordered based on evaluation results, such as predicted performance under the predetermined constraint conditions.

The term “visualization data” refers to data formatted for graphical representation, including values, labels, and layout parameters used to generate charts, graphs, or other visual elements.

The term “report materials” refers to digital documents or pages that aggregate visualization data, explanatory text, and related information, and are configured for presentation to a user via an external terminal.

The term “external terminal” refers to a user-operated computing device, such as a desktop computer, notebook computer, tablet, or mobile device, configured to communicate with the server, display report materials, and receive user input.

The term “change contents of the advertising activity plans” refers to modifications specified by a user via the external terminal, including changes to parameters such as budget allocation, media selection, timing, or target groups.

The term “explanatory text” refers to automatically generated narrative content that summarizes temporal transitions, competitor-related features, and prioritized advertising activity plans in a human-readable form.

The term “decision-making support” refers to assistance provided by the system to a user in evaluating and selecting advertising strategies, by supplying processed information, predictions, and recommendations derived from the described operations.

In one embodiment, a server executes a program that implements the claimed system using a hardware configuration including at least one processor, a main memory, a non-volatile storage device, and a network interface. The server uses a general-purpose central processing unit as the processor, semiconductor memory as the main memory, a magnetic or solid-state drive as the non-volatile storage device, and a wired or wireless network adapter as the network interface. The server runs an operating system and an application stack including an interpreter for a high-level programming language, a web framework, a database management system, and software libraries for text processing, machine learning, and visualization. For example, the server uses a language runtime such as a Python interpreter, a web framework such as a generic application framework, a relational database management system such as a generic SQL server, and libraries corresponding functionally to a markup parser (e.g., a library similar to BeautifulSoup), a web crawler (e.g., a library similar to Scrapy), a machine learning toolkit (e.g., a toolkit similar to Scikit-learn), and graph plotting toolkits (e.g., libraries similar to Matplotlib and Seaborn).

The server acquires information related to organizations and industrial fields, information related to economic tendencies, publicly disclosed information, and news information by issuing network requests through the network interface. The server accesses remote content sources such as web servers or remote databases, receives text-based responses, and stores the responses in the storage device as raw records. To make such raw information usable for subsequent computation, the server preprocesses the data by applying character-information processing technology. In one embodiment, the server uses text parsing algorithms to remove markup tags, scripts, navigation sections, and other non-content elements, and then converts the remaining textual segments into normalized character sequences in a unified character encoding.

The server converts the normalized text into feature data by using tokenization, normalization, and weighting algorithms. For example, the server applies a tokenization procedure to split a document into tokens, converts the tokens to lowercase, and removes language-specific stop words based on a stop-word list stored in memory. The server may apply lemmatization or stemming to reduce inflected forms to their base form. The server then computes a term-document matrix using a weighting scheme such as term frequency-inverse document frequency. The server stores this term-document matrix as a sparse matrix data structure in memory or the storage device, thereby enabling efficient processing of large volumes of documents.

The server calculates temporal transitions of terms and topics by combining the term-document matrix with timestamp information associated with each document. The server creates time-indexed feature vectors by aggregating term weights over specified time intervals, such as days, weeks, or months. The server then computes time-series representations for each term or topic, for example by summing or averaging normalized term weights for all documents in each time interval. By maintaining these time-series in dedicated data structures, the server avoids repeated parsing of raw data and permits efficient re-calculation of trend indicators when new data arrives.

The server extracts features related to actions of competitive entities by applying pattern detection algorithms and clustering or topic modeling algorithms to the term-document matrix and associated metadata. For example, the server identifies occurrences of competitor identifiers in the text, extracts contextual sentences surrounding such identifiers, and assigns those sentences to semantic clusters using a clustering algorithm such as k-means or a topic modeling algorithm such as latent Dirichlet allocation. The server then computes, for each competitive entity, feature vectors describing the frequency of detected actions (e.g., promotion launches, price changes, new product announcements) over time. Because these features are stored as structured, time-aware vectors, the server can later incorporate them directly into statistical learning models without re-processing the original text.

The server generates a prompt sentence for a generative AI model by programmatically composing textual instructions that encode the feature data, temporal transitions, and competitor-related features. In one embodiment, the server converts numerical trend data and competitor activity features into a compact textual summary using template-based text generation. For instance, the server may produce a summary such as “Mentions of eco-friendly vehicles increased by 35% over the last quarter, while competitor discounts have intensified in online channels.” The server then inserts such summaries, along with user-specified objectives and constraints, into a structured prompt sentence that is designed for machine consumption by the generative AI model. This process differs from manual prompt creation because the server directly uses internal feature data structures and temporal statistics to construct the prompt, thereby improving the reproducibility and completeness of the instructions.

The server transmits the generated prompt sentence to a generative AI model implemented as a neural network. In one embodiment, the generative AI model is a transformer-based language model comprising multiple self-attention layers, feed-forward layers, and layer normalization components. The model parameters include weight matrices and bias vectors that are optimized through a training process using a large corpus of text data. During training, the server (or a separate training system) minimizes a loss function, such as cross-entropy between predicted token distributions and ground-truth tokens, by performing backpropagation and weight updates using an optimization algorithm such as stochastic gradient descent or a variant such as Adam. The training process may incorporate data augmentation techniques such as random masking or sequence truncation to improve generalization.

At inference time, the server sends the prompt sentence as a sequence of tokens to the generative AI model and receives output tokens corresponding to generated text describing multiple proposal plans related to advertising activities. The server applies decoding strategies such as sampling with temperature control or beam search, where parameters such as maximum sequence length, temperature, and top-k or top-p sampling thresholds are adjustable and stored in configuration data. The server does not treat the generative AI model as a black box; rather, the server controls model parameters and decoding strategies to balance diversity and consistency of generated outputs, thereby improving technical performance in terms of convergence and stability.

The server converts the text output from the generative AI model into structured data by applying pattern extraction and parsing procedures. For example, the server detects sections or bullet points in the generated text that correspond to individual proposal plans and then identifies fields such as target audience, key messages, media channels, and budget suggestions using pattern-matching rules or shallow parsing models. The server maps each detected element into a predefined schema and stores the results as structured records in the storage device. This structured representation enables the server to perform downstream numerical evaluation and prioritization without requiring manual re-entry or free-form interpretation.

The server evaluates each structured proposal plan using a statistical learning model configured to predict performance indicators such as click-through rate, conversion rate, or return on investment. In one embodiment, the server uses a regression model such as a gradient boosting regressor or a random forest regressor that has been trained on historical campaign data. The server represents each proposal plan as a feature vector, where features include media category indicators, normalized budget values, encoded target group attributes, message-type flags, and trend-related features derived from the earlier time-series analysis.

The server applies the trained regression model to each feature vector, thereby obtaining predicted index values. The server then applies an evaluation algorithm that considers predetermined constraint conditions, such as total budget, maximum number of channels, or minimum expected performance thresholds, and computes an aggregate score for each plan. Based on these scores, the server ranks the proposal plans, marks the highest-scoring plans as prioritized advertising activity plans, and records the ranking results in structured form. The server generates visualization data for figure generation by aggregating the temporal transitions, predicted index values, and prioritized advertising activity plans. The server constructs data tables representing time-series for key terms and metrics, distributions of predicted performance values, and allocations by media category and budget level. The server then uses visualization libraries running on the same processor, such as a plotting toolkit similar to Matplotlib or Seaborn, to compute layout coordinates for lines, bars, and other graphical primitives. The libraries generate raster or vector images that depict, for example, line charts of keyword trends, bar charts comparing predicted performance across plans, and scatter plots showing the relationship between budget and expected return. The server embeds references to these images into report materials, which may be HTML documents or other digital report formats stored on the storage device.

The server automatically generates explanatory text describing the temporal transitions, competitor-related features, and prioritized plans by using a summarization module. In one embodiment, the server uses a rule-based summarization engine that converts trend statistics and ranking results into template-based natural language, such as “Plan B is prioritized because it achieves the highest expected return under the specified budget constraint, leveraging the observed increase in interest in eco-friendly vehicles.” In another embodiment, the server provides the extracted numerical data and plan attributes as input to the generative AI model with a specialized prompt sentence for summarization. For example, the server may construct a prompt sentence such as “Summarize the following trend indices and ranked advertising plans for a report: [data description].” The server then uses the generated explanatory text as part of the report materials, thereby reducing user effort in interpreting complex analytic results and unifying textual and visual information.

The server transmits the report materials to a terminal operated by a user via the communication network. The terminal is configured as a client device including a display, input devices, a processor, and memory. The terminal executes a web browser or a dedicated application that sends requests to the server, receives the report materials, and renders the visualization data and explanatory text on the display. The terminal allows the user to review the temporal transitions, competitor behavior summaries, and prioritized advertising plans in an integrated interface.

The user interacts with the terminal to adjust parameters of the advertising activity plans. For example, the user changes budget allocations across media categories by adjusting sliders, modifies target group definitions by selecting demographic segments, or changes the weighting of objectives such as maximizing reach versus maximizing conversion. The terminal captures these changes as structured input data and transmits them back to the server. Upon receiving the change contents, the server updates the feature vectors associated with the proposal plans, re-applies the statistical learning model to obtain updated index values, and re-runs the prioritization logic. The server then regenerates relevant visualization data and explanatory text reflecting the updated evaluation and transmits the updated results to the terminal. This closed-loop interaction enables near real-time feedback to the user and optimized use of computational resources, because the server only recomputes affected portions of the evaluation pipeline based on structured change data, thereby reducing redundant processing.

The server also accepts prompt sentences directly input by the user via the terminal. The user enters a free-form prompt sentence specifying a desired advertising strategy focus or constraint. Examples of such prompt sentences include:
“Please propose an optimal advertising strategy for a new product launch in the electric vehicle market, considering competitor activities and recent market trends.”
“Considering the recent rise in eco-conscious consumer behavior and competitor discount campaigns, propose an advertising campaign for our new electric SUV targeting families, focusing on digital channels.”
“For our new skincare product targeting women in their 20s, considering current social media trends and competitors' influencer campaigns, propose an advertising campaign that maximizes engagement on Instagram and TikTok.”

The terminal sends the user-entered prompt sentence to the server, and the server forwards it to the generative AI model as an instruction. The server then receives new proposal plans generated by the model, converts them into structured data using the same parsing and schema-mapping procedures, evaluates them with the statistical learning model, and integrates them into the ranking and visualization pipeline. In this way, both system-generated and user-generated prompt sentences are processed within a unified technical framework, producing consistent, machine-evaluable outputs.

The described configuration provides technical improvements beyond simple automation of human tasks. By transforming unstructured text into structured, time-aware feature data and integrating those features directly into prompt generation, the server reduces repeated parsing operations and improves data reuse, which leads to improved processing speed and reduced computational overhead. By normalizing generative AI outputs into structured representations and applying predictive models with optimized feature vectors, the server increases the precision and consistency of performance estimates compared with ad hoc manual evaluations. By maintaining explicit data structures for trends, competitor actions, and plan attributes, and by executing rule-based or learned summarization within the same pipeline, the server improves data management and reduces memory fragmentation, which facilitates scaling to large datasets.

Furthermore, the server employs non-conventional processing sequences that differ from typical business workflows. In particular, the server does not merely emulate human reasoning; instead, the server uses explicit numerical feature extraction, time-series modeling, and constrained optimization based on predictive models to evaluate complex combinations of parameters that would be impractical for a human to compute in real time. The integration of a transformer-based generative AI model, controlled through programmatically constructed prompt sentences derived from machine-generated feature data, provides a novel interaction pattern between generative and predictive models that reduces communication overhead and enhances reproducibility. By reusing internal feature representations both for prompt construction and for downstream evaluation, the server reduces redundant serialization and parsing operations, thereby improving throughput and reducing latency when handling multiple concurrent user sessions.

In alternative embodiments, the server replaces or supplements the described transformer-based generative AI model with other neural network architectures, such as recurrent neural networks or convolutional sequence models, and uses different loss functions or optimization algorithms. The server may incorporate ensemble models, where outputs from multiple generative models are combined and filtered using a ranking network. The statistical learning model for evaluation may be implemented as a neural network regressor, a support vector machine, or a generalized linear model. Feature extraction techniques may include word embeddings, contextual embeddings, or dimensionality reduction techniques such as principal component analysis or singular value decomposition to produce compact feature vectors and further reduce memory usage.

The terminal may be implemented as a handheld device, a wearable device, or an in-vehicle device, and may present condensed versions of the visualization data optimized for limited screen size. The server may also adjust the compression and resolution of the transmitted visualization images to reduce communication load, using downsampling and adaptive encoding based on network conditions. In distributed embodiments, multiple servers may share the workload, where one server cluster specializes in data collection and feature extraction, another specializes in generative AI inference, and a third specializes in evaluation and visualization. In such configurations, the servers communicate via internal networks using structured messages, and each module can be scaled independently to handle larger amounts of data or more concurrent users.

By these configurations and variations, the server, the terminal, and the user cooperate to realize the claimed system, and the internal technical processing within the server improves the efficiency, accuracy, and scalability of computer-implemented decision support for advertising optimization in a manner that goes beyond mere business logic and provides concrete improvements to computer technology itself.

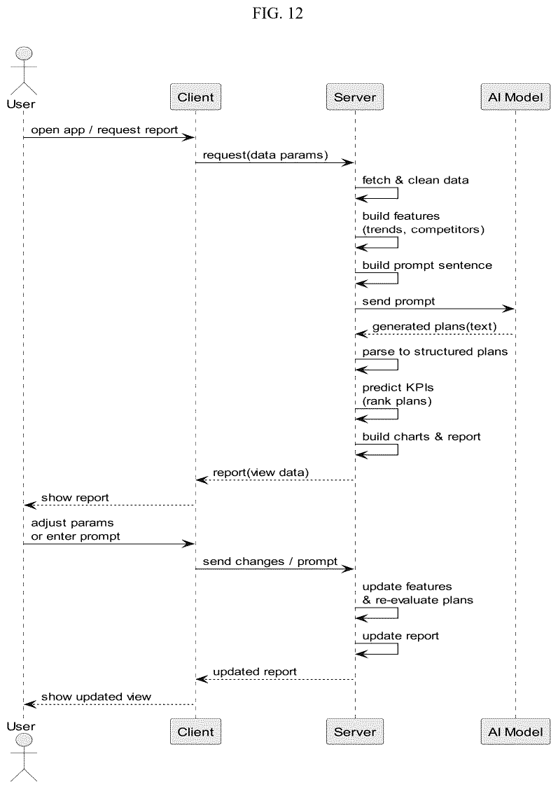

The following describes the processing flow using FIG. 12.

### Step 1:

The server acquires external information.

The server receives, as input, configuration parameters including organization categories, industry categories, keywords, and source identifiers stored in a configuration database.

Based on this input, the server generates network requests (for example, HTTP GET requests) and transmits them through a communication network to external content servers.

The server receives, as output, response data including web pages, news articles, and other text-based content, and stores these responses as raw records in a storage device together with metadata such as source URL, retrieval time, and document type.

### Step 2:

The server normalizes and cleans the acquired text.

The server reads, as input, the raw records stored in the storage device. The server removes markup tags, scripts, style elements, and navigation menus from the raw content using a markup parsing library and character filters. The server then converts the cleaned content into a unified character encoding, deletes control characters, and normalizes whitespace. The server outputs normalized text documents with associated metadata, and stores them in an intermediate data table for further processing.

### Step 3:

The server tokenizes and vectorizes the normalized text.

The server receives, as input, the normalized text documents and their metadata. The server splits each document into tokens using a tokenization algorithm, converts tokens to lowercase, removes stop words using a stop-word list, and optionally lemmatizes or stems tokens. The server then constructs a vocabulary and computes a term-document matrix using a weighting scheme such as term frequency-inverse document frequency. The server outputs a sparse matrix representing the documents and a vocabulary index, and stores these data structures in memory or a feature store.

### Step 4:

The server computes temporal transitions of terms and topics.

The server takes, as input, the term-document matrix, the vocabulary index, and timestamp data associated with each document. The server aggregates term weights across documents grouped by time intervals (for example, daily or weekly buckets), thereby computing for each term a sequence of weighted values indexed by time. The server applies smoothing or normalization operations (such as moving averages) to these sequences to reduce noise. The server outputs time-series vectors representing temporal transitions of terms and higher-level topics, and stores these as time-indexed feature data.

### Step 5:

The server extracts features related to competitive entities.

The server receives, as input, the normalized text documents, the vocabulary index, and a list of identifiers representing competitive entities. The server scans documents for occurrences of the identifiers and collects contextual windows around each occurrence. The server converts these context windows into vectors using the term-document or embedding representation and applies clustering or topic modeling algorithms to group similar contexts. Based on these clusters, the server labels actions (for example, launch, discount, collaboration) and counts their occurrences over time. The server outputs structured feature vectors describing competitive actions per entity and per time interval, and stores these vectors in a competitor-feature table.

### Step 6:

The server summarizes trends and competitor actions.

The server takes, as input, the temporal transitions of terms and topics and the competitor-feature vectors. The server computes summary statistics such as percentage increases, decreases, and volatility measures for selected terms and actions. The server then converts these statistics into fixed-length textual summaries using template-based generation (for example, “Mentions of [term] increased by [value] % over the last [period].”). The server outputs summary text blocks that represent market trends and competitor behaviors, and stores them in a summary storage area.

### Step 7:

The server constructs a prompt sentence for the generative AI model.

The server receives, as input, the summary text blocks, user-specified objectives (for example, “new product launch” or “maximize online engagement”), and constraint parameters (for example, budget range, target audience). The server combines these elements according to predefined prompt templates and inserts the summaries and constraints into the template. The server thereby generates a structured prompt sentence that encodes both contextual analysis and desired output structure. The server outputs one or more prompt sentences, and places them into a request queue for the generative AI model.

### Step 8:

The server interacts with the generative AI model to obtain proposal plans.

The server takes, as input, a prompt sentence from the request queue and parameter settings for the generative AI model (for example, decoding temperature, maximum token count). The server encodes the prompt sentence into tokens and transmits the token sequence to the generative AI model over an internal or external interface. The generative AI model returns, as output, generated text describing one or more proposal plans related to advertising activities. The server collects the generated text and stores it as raw model output associated with the corresponding prompt sentence.

### Step 9:

The server parses and structures the generated proposal plans.

The server receives, as input, the raw text output from the generative AI model. The server applies rule-based parsers and pattern-matching algorithms to detect boundaries between individual proposal plans and to identify fields such as media categories, target groups, appeal contents, and expenditure hints. The server maps the detected elements into a predefined schema, creating structured records for each plan. The server outputs a set of structured proposal plans and stores them in a structured-data repository.

### Step 10:

The server generates feature vectors for evaluation of proposal plans.

The server takes, as input, the structured proposal plans, the temporal transition vectors, and the competitor-feature vectors. The server encodes categorical fields (for example, media categories and target groups) into numerical representations such as one-hot or embedding vectors, scales numerical fields (for example, budgets) using normalization methods, and appends trend-related features derived from the time-series data. The server concatenates these elements into fixed-length feature vectors per proposal plan. The server outputs evaluated-ready feature vectors, which it then supplies to a statistical learning model.

### Step 11:

The server predicts performance indicators for proposal plans.

The server receives, as input, the feature vectors for proposal plans and a trained statistical learning model stored in memory. The server passes each feature vector through the model, which applies learned parameters to compute predicted values of performance indicators, such as expected click-through rate or expected return on investment. The server outputs predicted index values per proposal plan and attaches these predictions to the corresponding structured records in the structured-data repository.

### Step 12:

The server evaluates and prioritizes proposal plans under constraints.

The server takes, as input, the structured proposal plans, the predicted index values, and predetermined constraint conditions (for example, total budget limit or maximum number of channels). The server computes aggregate scores for each plan by combining index values with constraint-related penalties or weights using an evaluation formula. The server filters out plans that violate hard constraints and sorts the remaining plans in descending order of their aggregate scores. The server outputs a ranked list of prioritized advertising activity plans, and stores the ranking results for subsequent visualization and reporting.

### Step 13:

The server prepares visualization data.

The server receives, as input, the temporal transitions of key terms and topics, the predicted index values, and the ranked list of prioritized plans. The server aggregates these inputs into visualization-ready tables, such as time-series tables for trends, data series for plan performance, and distribution tables for budget and channel allocations. The server encodes axis labels, legends, and color assignments in data structures compatible with visualization libraries. The server outputs structured visualization data sets and passes them to the visualization module.

### Step 14:

The server generates graphical representations and report materials.

The server takes, as input, the visualization data sets and the ranked plan information. The server uses a plotting library to compute chart layouts and render images such as line charts, bar charts, and scatter plots. The server then embeds the generated images and accompanying textual summaries into report materials formatted as, for example, HTML pages or document files. The server outputs complete report materials containing both graphical and textual elements, and stores them in the storage device for delivery.

### Step 15:

The server transmits report materials to the terminal.

The server receives, as input, a request from the terminal identifying a specific analysis session or report. The server retrieves the corresponding report materials from the storage device and packages them into a response payload, which may include HTML code, image files, and metadata. The server sends this payload over the communication network to the terminal. The server outputs a delivered report that is ready for rendering on the terminal.

### Step 16:

The terminal displays the report and receives user adjustments.

The terminal takes, as input, the report materials from the server. The terminal renders graphs, tables, and explanatory text on its display using a browser or client application. The terminal provides interactive interface components, such as sliders, dropdown lists, and buttons, for modifying parameters of the advertising activity plans. The terminal collects user adjustments (for example, changes in budget, media selection, or target groups) as structured input data. The terminal outputs these change contents as a formatted request to the server.

### Step 17:

The server updates evaluation based on user adjustments.

The server receives, as input, the change contents of the advertising activity plans from the terminal. The server identifies which proposal plans and which parameters are affected and updates the corresponding structured records. The server recalculates feature vectors reflecting the new parameter values and re-applies the statistical learning model to obtain updated predicted index values. The server re-runs the evaluation and prioritization logic under the same or updated constraint conditions. The server outputs revised ranked plans and updated visualization data and stores them for renewed reporting.

### Step 18:

The server and terminal present updated results.

The server takes, as input, a request from the terminal to refresh the displayed information.

The server retrieves the revised ranked plans, updated index values, and regenerated visualization data, and constructs updated report materials. The server transmits these updated materials to the terminal. The terminal receives, as input, the updated materials, refreshes the displayed charts and summaries, and shows the new prioritized plans to the user. The terminal outputs an updated user interface reflecting the most recent evaluation results.

### Step 19:

The user provides custom prompt sentences to refine proposals.

The user views, as input, the displayed report and may decide to refine or redirect the proposal generation. The user enters a custom prompt sentence into an input field on the terminal, specifying additional constraints or strategic focus. The terminal captures the textual prompt and sends it as output to the server in association with the current analysis context.

### Step 20:

The server processes custom prompt sentences and integrates new proposals.

The server receives, as input, the user-provided prompt sentence and the current analysis context (trend summaries, competitor features, or constraints). The server optionally augments the prompt with internal context information and forwards it to the generative AI model. The server obtains, as output, newly generated proposal plans, parses and structures them using the same schema as existing plans, generates feature vectors, predicts performance indicators, and incorporates these plans into the evaluation and prioritization pipeline. The server outputs an expanded ranked list of plans, updated visualization data, and corresponding report materials, which are then delivered to the terminal for display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented decision-support systems that analyze business information and generate reports suffer from several technical limitations in how data is acquired, processed, and transformed into machine-understandable and human-consumable outputs. First, many existing systems rely on ad hoc data collection and manual preprocessing, resulting in heterogeneous, incomplete, and poorly aligned datasets. This leads to inefficient use of memory and processor resources, causes repeated parsing and transformation of the same information, and makes it difficult for the system to build stable statistical or simulation models without substantial human intervention.

Second, traditional report-generation workflows often separate numerical computation from text generation, so that statistical outputs and narrative explanations are produced in disconnected subsystems. As a result, the computing platform must perform additional data marshaling and format conversions to reuse analysis results in downstream processes, which increases latency, consumes excessive input/output bandwidth, and complicates error handling. This fragmented pipeline makes it difficult to automatically produce consistent, analysis-driven narrative content, and to scale the system to large numbers of concurrent decision-support tasks.

Third, when large-scale information is used for scenario simulation, existing systems typically compute only point estimates or simple summaries, without systematically generating structured simulation-result data such as distribution information, success probabilities, expected values, and downside-risk indices in a form that can be programmatically reused. Consequently, it is technically difficult to build automated, iterative Monte Carlo-type simulations that directly feed subsequent processes, and to maintain traceability between raw input data, intermediate analysis results, and final reports. Fourth, generative language models are often invoked in a coarse-grained, generic manner, for example by giving them natural language prompts that are manually crafted and not tightly coupled to the internal data structures of the analytical pipeline. This leads to a technical inefficiency in how the processor interacts with the generative language model: the system cannot systematically generate prompts from structured performance-evaluation indices and simulation-result data, nor can it reliably map generated text back into specific report sections. As a result, the computing system does not fully leverage the capabilities of the generative model, and additional human curation is required to integrate narrative content into reports.

Fifth, existing architectures rarely provide a unified control flow in which the same processor (or tightly coordinated processing units) orchestrates (i) network-based data acquisition, (ii) statistical modeling, (iii) random-number-based scenario simulation, (iv) automatic prompt synthesis for a generative model, and (v) templated document generation, while maintaining a consistent identifier linking all artifacts for a given analysis request. This lack of integration hinders scalability, increases complexity of software components, and degrades reliability when deployed as a networked service delivering electronic documents to user terminals on demand.

Accordingly, there is a need for an improved computer-implemented system and method in which a processor automatically transforms heterogeneous network-acquired information into normalized analysis-target data, constructs probabilistic or regression models, executes iterative simulations to produce structured simulation-result data, algorithmically generates prompt sentences tailored to those results for a generative language-processing device, and integrates the generated text with tables and images into an electronic report document that can be provided to user terminals. Such a system should improve the technical efficiency, scalability, and consistency of the end-to-end decision-support pipeline, while reducing manual intervention in data preparation and narrative report creation.

The specific processing by the specific processing unit 290 of the data processing device 12 in Example 2 is realized by the following means.

The present invention provides a server comprising a processor configured to receive identification information of information resources via a communication network, acquire structured or unstructured information from public information sources using standardized communication protocols, and store the acquired information in a storage device; to perform data-conversion processing, missing-value processing, unit-conversion processing, and time-series alignment processing on the stored information so as to generate analysis-target data for statistical processing; to execute statistical-analysis processing and numerical-analysis processing on the analysis-target data to calculate performance-evaluation indices including growth-trend indices, profitability indices, risk indices, and correlation indices, and to construct a probabilistic model or a regression model based on the performance-evaluation indices; to execute, by using the probabilistic model or the regression model and the analysis-target data, iterative computation based on random-number generation processing so as to generate a plurality of future scenarios and calculate an evaluation value for each scenario, thereby generating simulation-result data including distribution information, success probability, expected value, and downside-risk indices; to generate, from the simulation-result data and the performance-evaluation indices, table-format data, image data, and summary-text data, and to generate report-document data by placing the table-format data, the image data, and the summary-text data into a document-generation template, and output the report-document data in an electronic-document format; to generate, by using analysis-result data including the performance-evaluation indices and the simulation-result data, at least one prompt sentence that instructs a generative language-processing device to generate an explanatory sentence, a summary sentence, or a proposal sentence for decision support, to transmit the at least one prompt sentence to the generative language-processing device, and to integrate generated text received from the generative language-processing device into the report-document data; and to transmit, in response to a request from a user terminal, the report-document data in the electronic-document format to the user terminal. This enables an integrated and technically improved processing pipeline in which the server automatically transforms heterogeneous network-acquired information into normalized analysis-target data, constructs and executes simulation models using efficient random-number-based iterative computation, programmatically generates and manages prompt sentences for a generative language-processing device, and deterministically integrates structured analytical outputs and generated narrative text into electronic report documents that can be delivered to user terminals with reduced latency, improved scalability, and reduced need for manual data preparation and report authoring.

The term “processor” refers to a hardware and/or software processing unit, such as a central processing unit or a combination of processing circuits and executable instructions, that is capable of executing programmed operations to perform the functions described in the present disclosure.

The term “communication network” refers to a wired or wireless data communication infrastructure, including local-area networks, wide-area networks, and public packet-switched networks, over which digital data can be transmitted between the server, information sources, and user terminals.

The term “identification information of information resources” refers to data that specifies one or more information sources to be accessed, such as network addresses, uniform resource locators, or other resource identifiers used to locate and retrieve information via a communication network.

The term “public information sources” refers to information-providing systems or repositories that are accessible via a communication network without requiring bespoke point-to-point integration, including web servers, online databases, and open data services. The term “standardized communication protocols” refers to commonly used communication rules and formats, such as hypertext transfer protocols or other standardized application-layer protocols, that enable interoperable data exchange between computing devices over a communication network.

The term “structured information” refers to digital data organized according to a defined schema or format, such as tabular data, markup-based data, or other machine-parsable formats with explicitly defined fields and relationships.

The term “unstructured information” refers to digital data that is not organized according to a predefined schema, such as free-form text, natural-language documents, or other content that requires parsing or analysis to extract explicit structure.

The term “storage device” refers to a physical or virtual data-storage component, such as a magnetic disk, solid-state memory, or network-attached storage, configured to store digital information for subsequent processing and retrieval.

The term “data-conversion processing” refers to operations for transforming data from one representation to another, such as changing data types, normalizing formats, or reconciling heterogeneous schemas, to enable uniform processing.

The term “missing-value processing” refers to operations for detecting, imputing, or otherwise handling absent or undefined data elements in a dataset, using rules or algorithms, so that the dataset can be reliably used in subsequent analysis.

The term “unit-conversion processing” refers to operations for converting values expressed in different physical or monetary units into a common unit system, based on predetermined conversion factors or reference tables.

The term “time-series alignment processing” refers to operations for aligning data points with respect to a common temporal axis, including resampling, interpolation, or shifting of timestamps, so that values from different sources or periods can be consistently compared or aggregated.

The term “analysis-target data” refers to preprocessed and normalized digital data that has been prepared for application of statistical-analysis processing and numerical-analysis processing.

The term “statistical-analysis processing” refers to computational operations that derive numerical characteristics from data, such as calculation of averages, variances, correlations, distributions, and regression parameters.

The term “numerical-analysis processing” refers to computational operations that perform quantitative calculations, optimizations, or solutions of mathematical models, including iterative methods and model fitting, based on numerical data.

The term “performance-evaluation indices” refers to numerical measures derived from analysis-target data that represent performance characteristics of an object of analysis, such as growth, profitability, risk, and relationships between variables.

The term “growth-trend indices” refers to performance-evaluation indices that quantify temporal changes or tendencies in values over time, such as growth rates, trend slopes, or related indicators.

The term “profitability indices” refers to performance-evaluation indices that quantify the ability of an entity or activity to generate profit or return, such as margin ratios or return ratios.

The term “risk indices” refers to performance-evaluation indices that quantify variability, uncertainty, or downside exposure associated with an entity or activity, such as volatility measures or loss-probability measures.

The term “correlation indices” refers to performance-evaluation indices that quantify the degree of association between two or more variables, such as correlation coefficients or related dependency measures.

The term “probabilistic model” refers to a mathematical representation that describes the probabilistic behavior of one or more variables, including conditional probabilities or probability distributions, based on observed data.

The term “regression model” refers to a mathematical representation that approximates a relationship between dependent variables and independent variables, using fitted parameters derived from observed data.

The term “random-number generation processing” refers to computational operations that produce pseudo-random or quasi-random numeric values according to one or more probability distributions for use in simulations or sampling.

The term “future scenarios” refers to multiple hypothetical realizations of future states or outcomes generated by applying a model and random-number generation processing to analysis-target data.

The term “evaluation value” refers to a numeric or categorical measure calculated for each future scenario, representing a quality, performance, or desirability of that scenario.

The term “simulation-result data” refers to digital data produced by executing simulations, including evaluation values for individual scenarios and aggregated measures such as distributions, probabilities, expectations, and risk measures.

The term “distribution information” refers to data describing the frequency or probability distribution of evaluation values or other quantities across simulated scenarios.

The term “success probability” refers to a probability measure included in simulation-result data that represents the likelihood that a defined success condition is satisfied by simulated outcomes.

The term “expected value” refers to a statistical expectation, such as the mean or weighted average of evaluation values across simulated scenarios.

The term “downside-risk indices” refers to measures of adverse or lower-tail outcomes in simulation-result data, such as probabilities or magnitudes of loss below a threshold.

The term “table-format data” refers to information arranged in a structured tabular layout, including rows and columns, suitable for display in a table within a document.

The term “image data” refers to graphical content, such as charts or diagrams, encoded as digital images for inclusion in electronic documents.

The term “summary-text data” refers to textual content that concisely describes or interprets analysis results, generated or prepared for inclusion in a report.

The term “document-generation template” refers to a predefined structural pattern or layout specification that defines sections, placeholders, and formatting rules for generating report documents.

The term “report-document data” refers to composite digital content representing a report, including text, tables, and images arranged according to a document-generation template.

The term “electronic-document format” refers to a digital file format suitable for storage, transmission, and display of documents, such as a portable document format or similar.

The term “analysis-result data” refers to data that includes one or more performance-evaluation indices, simulation-result data, or other outputs derived from analysis-target data.

The term “prompt sentence” refers to machine-readable textual instructions formed by the processor and provided to a generative language-processing device to specify a content-generation task.

The term “generative language-processing device” refers to a computing system or service, such as a generative artificial intelligence model, that receives prompt sentences and outputs generated text based on the prompts.

The term “explanatory sentence” refers to generated text that explains or interprets one or more aspects of analysis-result data.

The term “summary sentence” refers to generated text that provides a concise overview or abstraction of one or more aspects of analysis-result data.

The term “proposal sentence” refers to generated text that suggests actions, recommendations, or options based on analysis-result data.

The term “generated text” refers to natural-language output produced by a generative language-processing device in response to one or more prompt sentences.

The term “user terminal” refers to an end-user computing device, such as a personal computing device or a mobile communication device, that communicates with the server and presents report-document data to a user.

In one embodiment, a server implements the claimed system as a network-accessible decision-support platform. The server includes at least one hardware processor, a main memory, a non-volatile storage device, and a network interface. The processor is, for example, a general-purpose central processing unit executing an operating system such as a UNIX-like operating system. The memory stores executable modules and data structures used to implement the functions described below. The storage device stores crawled data, preprocessed data, analysis results, trained models, and generated report documents. The network interface connects the server to external information sources and to terminals operated by users.

A terminal is, for example, a personal computing device or a mobile communication device. The terminal executes a web browser or a dedicated client application. The terminal sends analysis requests to the server and receives electronic report documents. A user operates the terminal through a graphical user interface to specify analysis targets and to view generated reports.

The server uses software components including, but not limited to, a web application framework (for example, an HTTP server and request router), a scripting environment such as a programming language runtime, a data analysis library such as a table-processing library and a numerical-computation library, a statistical library such as a distribution-fitting library, a visualization library such as a plotting library, and a document-generation system such as a structured-markup compiler or a programmatic PDF generation library. The server also communicates with an external generative AI model exposed via an application programming interface.

The server acquires information from public information sources by using standardized communication protocols over the communication network. The server receives, from the terminal, identification information of information resources, such as network addresses of corporate disclosure pages, industry reports, and news feeds. The server uses an HTTP client library to transmit requests to these addresses and receives HTML documents or other content. The server parses the received HTML using a document-parsing library such as an HTML tree parser to identify elements that contain financial figures, dates, text segments describing events, and metadata. The server transforms the parsed content into structured records having fields such as entity identifier, reporting period, revenue amount, operating profit amount, cash-flow amount, leverage ratio, and textual description.

The server stores these records in a relational database management system. The server uses database tables with defined schemas, for example, a financial-data table with columns for entity, period, metric type, value, and unit; an event-data table with columns for entity, date, event type, headline, and text body; and a source-metadata table with columns for source URL, retrieval time, and parsing status. This explicit structuring of heterogeneous input data into normalized tables enables later statistical processing to be executed using vectorized operations, thereby improving processing speed and memory locality compared to ad hoc processing of raw text.

The server executes preprocessing operations on data stored in the database to generate analysis-target data. The server loads data into memory as tabular objects. The server performs data-conversion processing by transforming string-encoded numbers into binary numeric representations, harmonizing date formats into a single epoch-based representation, and mapping textual metric labels to standardized metric identifiers. The server performs missing-value processing by applying rules such as forward-filling previous values, interpolating between known observations, or discarding incomplete records when coverage falls below a threshold rate. The server performs unit-conversion processing by consulting reference tables that store unit-conversion factors, such as currency exchange rates and magnitude scaling factors, and applying these factors to values so that all stored metrics use a consistent unit system. The server performs time-series alignment processing by constructing time-indexed arrays for each entity and metric, reindexing data onto a common timeline (for example, quarterly or annual), and filling or aggregating values as needed. By performing these operations in a controlled sequence, the server reduces data inconsistencies and enables later algorithms to operate on dense, regularly indexed matrices, which improves cache utilization and reduces the number of conditional branches during computation, thereby increasing throughput.

The server computes performance-evaluation indices from the analysis-target data. The server uses a numerical-computation library to compute growth-trend indices such as compound growth rates and linear trend coefficients by applying regression formulas to sequences of values. The server computes profitability indices such as margin ratios and return ratios by dividing relevant aggregated metrics. The server computes risk indices such as standard deviations, semi-deviations, and value-at-risk measures using built-in statistical functions. The server computes correlation indices by generating covariance matrices and then normalizing by variance components. The server stores the resulting indices in an analysis-result table, where each record includes an entity identifier, a metric identifier, a time horizon, a numeric value, and a confidence interval where applicable.

The server constructs predictive models from the performance-evaluation indices and related features. In one embodiment, the server constructs a logistic regression model to estimate a success probability of a contemplated transaction. The server selects features including normalized leverage ratios, growth-trend indices, profitability indices, and indicators representing sector classification and transaction size. The server constructs a feature matrix and a target vector from historical labeled data stored in the database. The server initializes model parameters and applies a gradient-based optimization algorithm to minimize a logistic loss function. The server performs iterative updates of parameter vectors until convergence criteria, such as a small change in loss or reaching a maximum number of iterations, are satisfied. The server stores the trained parameters and hyperparameters in a model repository as serialized binary objects. By executing this training process directly on normalized, time-aligned, and unit-consistent data, the server reduces model instability and reduces the need for repeated manual tuning, thereby improving predictive accuracy.

In another embodiment, the server uses a feed-forward neural network model as the generative AI model exposed externally. While the generative AI model itself may be hosted by a separate provider, the server operates on the assumption that the generative AI model comprises multiple layers including an input embedding layer, multiple attention-based layers, and an output projection layer trained on large corpora. The server does not modify the internal weights of this generative AI model in real time but interacts with it via prompt sentences. The server, however, models the behavior of the generative AI model by inspecting previous responses and can adjust future prompt sentences accordingly.

The server also executes scenario simulations using a Monte Carlo approach. The server uses the probabilistic model or regression model and the analysis-target data to define distributions of key variables such as revenue growth rate, margin volatility, and macroeconomic factors. The server uses a random-number generation module implementing pseudo-random generators and distribution samplers. For each simulated scenario, the server samples values from defined distributions, computes future financial trajectories by iterative application of growth and margin functions, and then computes an evaluation value such as net present value by discounting future cash flows using a specified discount rate. The server repeats this process for a large number of iterations, for example ten thousand or more, storing intermediate results in memory-efficient arrays. The server then aggregates these arrays to compute distribution information, success probabilities (proportion of scenarios with evaluation value above a threshold), expected values (means), and downside-risk indices (for example, quantiles at specified confidence levels). By implementing these operations in a vectorized manner and avoiding repeated parsing of input data, the server reduces processor cycles and memory transfers, leading to shorter runtime and more efficient use of hardware resources.

The server prepares report-document data by integrating numerical and textual elements. The server uses a visualization library to generate image data representing time-series plots of performance metrics, histograms of simulated evaluation values, and bar charts comparing scenarios. The server encodes these images into raster or vector formats and stores them as image files with descriptive names referencing an analysis identifier. The server uses tabular-processing routines to convert sets of metrics into table-format data, such as tab-delimited or markup-based table definitions. The server generates summary-text data by applying rule-based templates to selected indices, for example producing sentences such as “The expected value of the transaction is X with a downside risk of Y at the Z confidence level.” These rule-based templates use deterministic substitution rules, ensuring that textual summaries accurately and consistently reflect numeric values and their relationships.

The server constructs prompt sentences for the generative AI model using the analysis-result data, including performance-evaluation indices and simulation-result data. The server uses template structures that embed variables into natural-language strings. For example, the server may generate prompt sentences such as:
“Using the following statistics and simulation results, write a clear executive summary of this M&A evaluation for board members. Describe the target company's financial trends, the estimated probability of a positive NPV (68%), the main risk factors (integration risk, regulatory risk, and market volatility), and your overall recommendation.”
“Based on the time-series financial data and Monte Carlo simulation outputs (including the distribution of NPV and IRR), generate a detailed ‘Risk and Cost-Effectiveness Analysis’ section. Explain the downside scenarios, the likelihood of value destruction, and the conditions under which this deal would be acceptable.”
“You are preparing an M&A report for senior management. Using the provided growth rates, leverage ratios, and modeled synergy effects, draft a narrative section titled ‘Strategic Rationale and Expected Synergies,’ focusing on how the acquisition supports long-term strategic goals.”
“Given the historical performance metrics and the simulated future cash-flow distributions, create a concluding section titled ‘Overall Assessment and Next Steps.’ Summarize whether the acquisition is advisable, highlight critical uncertainties, and propose concrete next steps for due diligence.”

The server embeds current numeric values, metric names, scenario labels, and user-specified constraints into these template strings, thereby producing prompt sentences that are tightly aligned with the internal data structures. This approach goes beyond manual free-form prompting; it systematically binds structured data to prompt positions, which reduces ambiguity and improves the reliability and consistency of the responses produced by the generative AI model. The server transmits the prompt sentences via a network interface to the generative AI model endpoint, receives generated text, and stores the generated text in association with the corresponding analysis identifier and report section identifier. The server integrates the generated text into the report-document data by using a document-generation template. The server selects appropriate sections (such as an executive summary, a risk analysis section, and a recommendation section) and inserts the corresponding paragraphs of generated text, along with tables and figures. The server then compiles the document template into an electronic-document format. When a structured-markup-based compiler is used, the server generates a source file conforming to a document language and then calls a compilation command-line tool to produce a final document file. When a programmatic library is used, the server issues drawing commands to construct pages, place text at coordinates, and embed images. The resulting file is stored in the storage device and indexed by a unique analysis identifier.

The terminal accesses the generated report-document data by issuing a request to the server. The terminal receives, from the server, document metadata and an electronic document file. The terminal stores the received file and presents a download link or opens the file within the terminal's document viewer. The user views the report on the terminal, examining charts, tables, and narrative sections.

This configuration provides technical improvements beyond mere automation of human tasks. By automating the normalization of heterogeneous network data into analysis-target data, the server reduces redundancy in parsing and cleaning operations, reducing computational overhead and improving processing speed. By constructing probabilistic or regression models directly over normalized data, the server stabilizes parameter estimation and improves prediction accuracy. By implementing vectorized Monte Carlo simulation that works on dense arrays and uses efficient random-number generation, the server reduces execution time and memory fragmentation compared to naïve loop-based simulation implementations. By generating structured prompt sentences that are automatically derived from internal data structures, the server reduces communication overhead with the generative AI model, decreases the likelihood of inconsistent or irrelevant generated content, and simplifies mapping of outputs back into the internal representation, improving data management and reducing error rates.

In another embodiment, the server uses a neural-network-based classifier to select which metrics to highlight in the prompt sentences. The server constructs a feed-forward network with an input layer corresponding to a feature vector that encodes performance-evaluation indices and user preferences, one or more hidden layers with non-linear activation functions, and an output layer representing a relevance score for each metric. The server trains this classifier using supervised learning with a cross-entropy loss function and gradient-based optimization. The server uses the trained classifier to automatically prioritize indices that have historically been important in similar decisions. By doing so, the server further optimizes the length and focus of prompt sentences, reducing the amount of data transmitted to the generative AI model and focusing computation on the most informative content, which reduces communication load and model processing time.

In a further embodiment, the server uses a caching layer for preprocessed data and intermediate analysis results. The server assigns each analysis request a key determined by input parameters and data version identifiers. When a new request arrives, the server checks whether identical or similar requests have been processed recently. If so, the server retrieves precomputed indices and simulation-result data from the cache instead of recomputing them, thereby improving overall throughput and reducing processor and memory use.

In a different embodiment, the server is implemented as a distributed system comprising multiple coordinated computing nodes. One node may specialize in data acquisition and preprocessing, another node may specialize in statistical modeling and simulation, and another node may specialize in report generation and interaction with the generative AI model. The nodes communicate via message queues or remote procedure calls. This division of labor allows parallelism in processing large-scale datasets and supports horizontal scaling, improving system responsiveness when handling many concurrent user requests.

The described embodiments focus on internal computational techniques rather than business logic. The server is configured to execute specific data-structure transformations, algorithmic procedures for model training and simulation, and protocol-based interactions with a generative AI model to achieve technical benefits such as improved processing speed, improved prediction and simulation accuracy, improved data management consistency, and reduced communication and storage overhead. By enabling the server to automatically and deterministically control the flow of information from raw network sources to structured analytical indices, to simulation results, to prompt sentences, and finally to integrated report documents, the system provides a concrete technical improvement to computer-based decision-support architectures, rather than simply automating an existing manual reporting workflow.

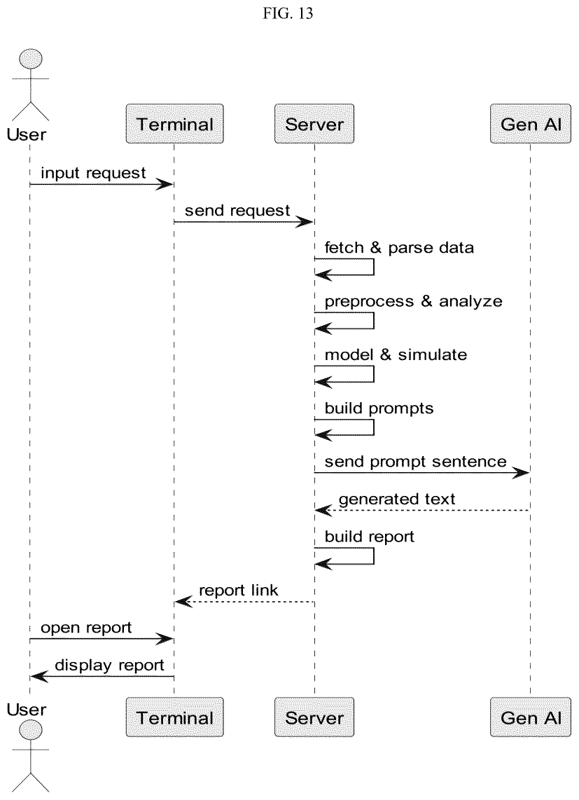

The following describes the processing flow using FIG. 13.

### Step 1:

The user operates the terminal to initiate an analysis request. The terminal displays input fields for resource identifiers (such as URLs or entity codes), analysis parameters (such as time horizon, currency, and simulation depth), and output preferences (such as language and report sections). The user enters these values and confirms the request.

Input: User-specified resource identifiers and analysis parameters entered on the terminal.

Processing: The terminal packages the inputs into a structured request object and performs basic validation (for example, checking that URLs are syntactically valid and required fields are not empty).

Output: The terminal sends an HTTP or HTTPS request containing the structured request object to the server.

### Step 2:

The server receives the analysis request from the terminal. The server validates the request content, checks authentication or authorization if required, and assigns a unique analysis identifier. The server records the request, with the analysis identifier, in a job management table or queue for downstream processing.

Input: Structured request object containing resource identifiers, analysis parameters, and output preferences.

Processing: The server parses the request payload, verifies data types, checks for missing parameters, and generates a unique analysis identifier. The server stores the request parameters and status (for example, “pending”) in a database table keyed by the analysis identifier.

Output: The server returns an acknowledgment with the analysis identifier to the terminal and enqueues a processing job associated with that identifier.

### Step 3:

The server acquires raw information from public information sources. The server reads the resource identifiers corresponding to the analysis identifier from the database and issues network requests to those resources. The server uses an HTTP client to request HTML pages, structured data files, or other content from web servers or data services.

Input: Resource identifiers and retrieval parameters associated with the analysis identifier.

Processing: The server iterates over the resource identifiers, performs HTTP GET operations, and receives responses containing HTML documents or other media. The server checks HTTP status codes and response headers to confirm successful retrieval and records retrieval metadata.

Output: The server stores the raw content, along with source metadata (such as URL and retrieval time), in a raw-data storage area in the database or in a file store.

### Step 4:

The server parses and normalizes the acquired content into structured records. The server applies an HTML or document parser to each raw content item, extracting table elements, text blocks, date fields, and numeric values. The server maps extracted values to standardized fields using preconfigured parsing rules and dictionaries.

Input: Raw content documents and associated metadata retrieved in Step 3.

Processing: The server constructs document object models from HTML, locates elements containing financial metrics or event descriptions, and extracts text and numeric strings. The server converts numeric strings to binary numeric types, cleans whitespace, and maps labels (for example, “Sales” or “Revenue”) to standardized metric identifiers. The server also parses date strings into a unified timestamp format.

Output: The server writes structured records into relational tables, such as a financial-data table and an event-data table, each record linked to the analysis identifier and the source metadata.

### Step 5:

The server preprocesses the structured records to generate analysis-target data. The server loads relevant records for the analysis identifier into in-memory tabular structures. The server applies data-conversion processing, missing-value processing, unit-conversion processing, and time-series alignment processing

Input: Structured records from the financial-data and event-data tables linked to the analysis identifier.

Processing: The server converts fields to consistent data types, detects and fills missing numeric entries using predefined rules, converts currency and unit magnitudes using reference tables, and reindexes data onto a regular timeline (for example, yearly or quarterly). The server resolves overlapping or duplicate records and aggregates values as needed.

Output: The server produces analysis-target data in the form of regular, dense time-series arrays or tables, and stores them in analysis-ready tables keyed by entity and metric for the analysis identifier.

### Step 6:

The server computes performance-evaluation indices from the analysis-target data. The server calculates growth-trend indices, profitability indices, risk indices, and correlation indices.

Input: Analysis-target data for each entity and metric, including aligned time-series values.

Processing: The server applies numerical formulas: for example, computing growth rates by comparing current and prior periods, fitting simple regression lines over time to obtain trend slopes, computing ratios such as margin and return on capital, and calculating standard deviations and correlations using statistical functions. The server computes these indices across specified horizons (for example, one year, three years, five years).

Output: The server stores performance-evaluation indices in an analysis-result table, each record containing metric type, time horizon, numeric value, confidence interval where applicable, and a link to the analysis identifier.

### Step 7:

The server constructs a predictive model or uses a stored model to estimate outcome probabilities or values. The server selects input features from the performance-evaluation indices and other attributes such as sector identifiers and transaction size parameters.

Input: Performance-evaluation indices linked to the analysis identifier, along with configuration parameters for model selection.

Processing: The server builds a feature matrix and, when training, a target vector from historical labeled data. The server applies a statistical or machine-learning algorithm (for example, logistic regression or another regression model) to fit model parameters by minimizing a loss function. For inference, the server uses stored model parameters to compute predicted probabilities or continuous outcome estimates for the current analysis, using vector-matrix multiplications and activation functions.

Output: The server writes model output values, such as predicted success probabilities or expected returns, into a model-output table associated with the analysis identifier.

### Step 8:

The server performs Monte Carlo simulations or scenario generation based on the model and analysis-target data. The server defines distributions for key variables and executes many random draws to simulate future trajectories.

Input: Model parameters or predictive relationships from Step 7, analysis-target data, and simulation configuration (such as number of iterations and discount rate).

Processing: The server generates random numbers from defined probability distributions, applies those draws to the model equations, and computes trajectories of financial metrics across time for each iteration. For each simulated scenario, the server calculates an evaluation value such as net present value by summing discounted cash flows. The server accumulates evaluation values for all iterations into arrays and computes aggregate statistics, including distribution shapes, probabilities of meeting thresholds, expected values, and downside-risk indices.

Output: The server stores simulation-result data, including per-scenario or aggregated metrics, in simulation tables linked to the analysis identifier.

### Step 9:

The server prepares visual and tabular representations of analysis results. The server generates chart images and tabular summaries from the performance-evaluation indices and simulation-result data.

Input: Analysis-result data containing indices from Step 6 and simulation-result data from Step 8.

Processing: The server uses a plotting library to create graphs such as time-series charts, histograms, and scenario comparison plots. The server formats these graphs with labels and legends, and exports them as image files. The server constructs tables listing key indices, simulation statistics, and thresholds, formatting them as structured table definitions.

Output: The server stores references to the generated image files and table definitions in report-preparation tables, associated with specific sections of a report and the analysis identifier.

### Step 10:

The server generates prompt sentences for the generative AI model using analysis-result data and simulation-result data. The server inserts numeric values, labels, and qualitative descriptors into predefined natural-language template strings.

Input: Performance-evaluation indices, simulation statistics, model outputs, and report-section configuration for the analysis identifier.

Processing: The server selects template types corresponding to sections such as “Executive Summary,” “Risk Analysis,” or “Recommendation.” The server fills placeholders within the templates with actual values (for example, success probability, expected net present value, key risk indices) and contextual information (for example, time horizon, sector).

Output: The server produces one or more prompt sentences for each report section and stores them in a prompt table, with each prompt linked to the analysis identifier and the intended section.

### Step 11:

The server transmits the prompt sentences to the generative AI model and receives generated text. The server communicates with the external generative language-processing device via an API.

Input: Prompt sentences generated in Step 10 and any additional control parameters (such as desired length or style).

Processing: The server forms request payloads containing the prompt sentences and sends them over the network interface to the generative AI model endpoint. The server receives responses containing generated text segments. The server validates the responses (for example, checking encoding and length) and associates each text segment with the corresponding prompt and report section.

Output: The server stores the generated text in a generated-text table, linked to the analysis identifier and the section identifiers.

### Step 12:

The server constructs report-document data by integrating numeric outputs, tables, charts, and generated text. The server populates a document-generation template with the collected content.

Input: Performance indices and simulation statistics, chart images, table definitions, rule-based summary text, and generated text from the generative AI model, all associated with the analysis identifier.

Processing: The server maps each content item to a position in the document template (for example, placing an executive summary paragraph at the beginning, followed by charts and tables in designated sections). The server merges static template elements (such as headings and footers) with dynamic content.

Output: The server generates a structured document representation, such as a markup-based source file or an in-memory document object, representing the complete report for the analysis identifier.

### Step 13:

The server renders the structured document representation into an electronic-document format. The server either compiles a markup-based document or uses a programmatic document library to create pages, place text, and embed images.

Input: Structured report-document representation produced in Step 12.

Processing: The server executes a document-rendering engine to convert the structured representation into a binary file in the selected electronic-document format. The server checks for rendering errors and, upon success, stores the rendered file in a document repository, recording its file path or storage identifier in a document index table.

Output: The server produces a final report file in an electronic-document format, linked in the database to the analysis identifier and available for retrieval.

### Step 14:

The terminal retrieves the generated report document from the server. The terminal periodically or on demand queries the server for the status of the analysis identifier and the availability of a report.

Input: Analysis identifier and status request from the terminal.

Processing: The server looks up the analysis identifier in the job management table, determines that the report is complete, and returns metadata including a download URL or binary data for the report file. The terminal receives this information and updates its user interface.

Output: The terminal obtains the report document file or a link to it and presents a download or view option to the user.

### Step 15:

The user views and utilizes the report document on the terminal. The user selects the download or view option, and the terminal opens the document in a viewer application.

Input: Report document file obtained by the terminal in Step 14.

Processing: The terminal invokes a document viewer capable of rendering the electronic-document format. The user inspects graphical charts, tables, and narrative sections generated through the combination of statistical analysis, simulation, and generative AI model outputs.

Output: The user obtains decision-support information displayed on the terminal, enabling the user to make informed decisions based on the integrated analytical and narrative content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional decision-support systems in business environments typically employ a fixed pipeline in which bulk external data is ingested, basic analytics are run, and static reports are produced. Such systems suffer from multiple technical limitations. First, data acquisition, text analysis, numerical analysis, simulation, and presentation are often implemented as loosely coupled modules without a unified feature representation. As a result, the system cannot efficiently reuse intermediate computations across different simulations or dynamically adjust simulation parameters at runtime, which leads to high computational cost, latency, and redundancy in storage and processing.

Second, existing architectures generally treat user interaction as a simple input-output channel and do not integrate real-time emotion information from the user into the core computation. Even if the user's emotional state is available (for example, from a separate user-experience module), that information is not systematically bound to simulation models, scenario selection, or the generation of machine-generated narratives. Consequently, the system cannot adapt its internal parameterization, scenario emphasis, or level of detail to the user's current cognitive and emotional context, which leads to ineffective use of computing resources and suboptimal presentation of information.

Third, in many systems that incorporate generative AI models, the construction of prompt sentences is performed manually or by static templates. This causes several technical problems: (i) the system cannot automatically encode simulation results, feature sets, and emotion labels into machine-optimized prompts; (ii) prompts are not iteratively refined based on logged interactions and outcomes; and (iii) the generative AI model is underutilized because it receives incomplete or poorly structured instructions. These limitations degrade the quality, consistency, and controllability of generated content and require human operators to frequently intervene, increasing processing time and reducing scalability.

Fourth, conventional report and dashboard generation is usually decoupled from the analytical core. Visualization components and document generators consume only aggregated outputs and do not receive fine-grained context such as emotion-aware scenario tags or prompt generation parameters. This decoupling prevents the system from automatically tuning display order, emphasis, and interaction flow according to user state and historical behavior, and limits the system's ability to provide a technically optimized user interface that minimizes cognitive load.

Accordingly, there is a need for a technical architecture and processing method that: (i) unifies text and numerical data into a shared feature set for simulation; (ii) incorporates real-time emotion recognition into simulation parameter control and scenario selection; (iii) automatically generates and refines prompt sentences for a generative AI model based on simulation results, emotion labels, and historical logs; and (iv) tightly couples visualization and document generation with these internal states, so that the system can automatically create emotion-aware, context-adaptive decision-support outputs with improved computational efficiency, responsiveness, and consistency. The present invention addresses these technical problems by providing a processor configuration that orchestrates data acquisition, feature generation, simulation, emotion conditioning, prompt construction, generative AI invocation, and adaptive output presentation in an integrated manner.

The specific processing by the specific processing unit 290 of the data processing device 12 in Application Example 2 is realized by the following means.

The present invention provides a server comprising a processor and a memory storing instructions which, when executed by the processor, cause the processor to acquire, via a communication network, structured data and unstructured data from external information sources, apply language processing algorithms and statistical computation algorithms to the acquired data to generate a unified feature set, execute simulation processing using a probabilistic model or a numerical analysis model based on the unified feature set to calculate distributions of evaluation indicators and generate visualization data, perform emotion recognition processing on image data and audio data obtained from a user terminal to calculate an emotion label and adjust simulation parameters or scenario selection in accordance with the emotion label, automatically generate a prompt sentence for a generative AI model based on the unified feature set, the simulation results, and the emotion label, invoke the generative AI model using the prompt sentence to obtain machine-generated analytical content and recommendation content, construct document data and material data by associating the machine-generated content with the visualization data, transmit the document data, the material data, and the visualization data to the user terminal with a display order and emphasis controlled in accordance with the emotion label, and record prompt sentences, emotion labels, simulation results, and outputs of the generative AI model as history data and update prompt generation rules and simulation settings based on analysis of the history data. This enables the server to technically improve end-to-end decision-support processing by reducing redundant computation through feature reuse, dynamically adapting simulation behavior and generative AI instructions to real-time user emotion, automatically optimizing prompts for the generative AI model based on accumulated interaction history, and generating emotion-aware, context-adaptive visual and textual outputs that enhance computational efficiency, responsiveness, and the technical quality of machine-generated decision-support content.

The term “system” refers to an arrangement of one or more hardware devices and software components that cooperate, via at least one communication network, to execute the processing described in the claims.

The term “processor” refers to a hardware computation unit, such as a central processing unit or other arithmetic and logic engine, capable of executing instructions stored in a memory to perform data processing operations.

The term “communication network” refers to any wired or wireless communication infrastructure that enables data exchange between the server, user terminals, and external information sources.

The term “structured data” refers to data organized in a predefined format, such as tabular data, records, or key-value pairs, including financial indicators, time series, and reference tables.

The term “unstructured data” refers to data that does not have a predefined schema, such as free-form text, news articles, reports, and multimedia content, from which information is extracted by processing.

The term “external information sources” refers to remote data providers accessible over a communication network, including network sites, remote databases, and application programming interfaces that supply business-related information.

The term “language processing algorithms” refers to software procedures that operate on text data to perform operations such as tokenization, part-of-speech tagging, entity extraction, sentiment evaluation, and topic extraction.

The term “statistical computation algorithms” refers to software procedures that perform numerical operations such as indicator calculation, missing-value processing, aggregation, and feature generation on numerical data.

The term “feature” refers to a numerical or categorical value derived from raw text or numerical data that represents a characteristic used as input to simulation models or other analytical processes.

The term “feature set” refers to a collection of features organized for a particular entity, scenario, or simulation instance and used as input to models for prediction or analysis.

The term “simulation” refers to a computational process that uses one or more models and input features to generate predicted outcomes, distributions, or scenarios for future or hypothetical states.

The term “probabilistic model” refers to a mathematical model that represents uncertainty in inputs or parameters using probability distributions and produces outputs in the form of probabilities or distributions.

The term “numerical analysis model” refers to a mathematical model that uses numerical methods, such as optimization, differential equation solving, or iterative computation, to approximate complex relationships among variables.

The term “evaluation indicator” refers to a quantitative metric, such as success probability, loss risk, cost-effectiveness, or other performance measure, used to assess a scenario or decision.

The term “distribution” refers to a statistical representation of possible values of an evaluation indicator, including probability density, cumulative probability, or empirical frequency of outcomes.

The term “scenario” refers to a defined set of assumptions or parameter values under which a simulation is executed to generate outcomes for a particular decision context.

The term “visualization data” refers to data structures suitable for rendering graphical representations of simulation results, such as chart parameters, image data, or plotting instructions.

The term “user terminal” refers to an end-user device, such as a computing terminal or portable communication device, that acquires user inputs and displays outputs received from the server.

The term “image data” refers to digital representations of visual information, including single frames or sequences of frames captured by an imaging sensor associated with the user terminal.

The term “audio data” refers to digital representations of sound captured by an audio sensor associated with the user terminal, including speech signals used for recognition and emotion analysis.

The term “emotion recognition processing” refers to computational operations that extract features from image data and audio data and determine an estimated emotional state of a user.

The term “emotion label” refers to a symbolic representation of a detected emotional state of a user, such as joy, neutrality, anxiety, or excitement, derived from emotion recognition processing.

The term “confidence level” refers to a numerical value indicating the reliability or probability associated with an emotion label or other estimated state.

The term “model parameter” refers to a numerical or categorical value that controls the behavior of a simulation model, such as distribution parameters, risk thresholds, or weighting factors.

The term “scenario selection” refers to a process of choosing one or more scenarios for execution, emphasis, or presentation based on predetermined rules or detected conditions, including emotion labels.

The term “prompt sentence” refers to a machine-readable instruction sequence in natural language or structured form that is supplied to a generative AI model to request generation of specific content.

The term “generative AI model” refers to a machine learning model capable of producing new content, such as text, in response to a prompt sentence, based on patterns learned from training data.

The term “analytical content” refers to machine-generated text that explains, interprets, or analyzes simulation results, evaluation indicators, or business situations.

The term “recommendation content” refers to machine-generated text that proposes actions, strategies, or choices in view of simulation results and evaluation indicators.

The term “document data” refers to structured data representing a textual document, including sections, headings, and body text, suitable for rendering as a report or long-form content.

The term “material data” refers to structured data representing presentation materials, including slides, graphical elements, and text segments, suitable for visual presentation to a user.

The term “display order” refers to a sequence in which elements such as charts, text sections, or scenarios are arranged for presentation on a user interface.

The term “emphasis” refers to a degree of visual or interactional highlighting applied to particular content elements, such as increased size, color intensity, or prominent placement on a display.

The term “interactive screen configuration” refers to an arrangement of user interface elements that allows user operations such as selection, navigation, and expansion of simulation-related information.

The term “history data” refers to accumulated records of prior interactions, including prompt sentences, emotion labels, simulation settings, simulation results, and outputs from the generative AI model.

The term “prompt generation rule” refers to a set of conditions and transformations used to construct or modify prompt sentences supplied to a generative AI model.

The term “simulation setting” refers to configuration information for a simulation, including selected models, time horizons, distributions, and thresholds used to generate outcomes.

The term “decision target” refers to a class of decisions, such as transaction condition determination, partner selection, organizational restructuring, capital alliance, or business acquisition, for which simulation and recommendation are performed.

The term “alternative proposal” refers to a machine-generated recommendation that differs from a primary option and provides an additional choice or path for a decision target.

The term “new scenario” refers to a machine-generated configuration of assumptions or parameters that was not explicitly requested by the user but is synthesized to explore additional possibilities.

The term “innovative decision making” refers to a process of selecting actions or strategies that depart from conventional patterns and are supported by automatically generated alternative proposals or new scenarios derived from data-driven analysis.

The server implements the claimed system using one or more general-purpose processors, system memory, non-volatile storage, and a network interface. The server executes software components including an operating system, a data acquisition module, a language processing module, a statistical computation module, a simulation module, an emotion-conditioning module, a prompt-generation module, an interface to a generative AI model, a visualization and document-generation module, and a history-analysis module. The server communicates with at least one terminal operated by a user via a wired or wireless communication network.

The terminal includes a processor, a memory, a display, an imaging sensor such as a camera, an audio sensor such as a microphone, and a network interface. The terminal executes application software or a browser-based application that provides user interfaces, captures image and audio data, and exchanges structured messages with the server using a communication protocol such as HTTPS over TCP/IP.

The server uses a data acquisition module implemented in a high-level programming language such as Python. The server uses libraries corresponding to HTML parsing tools (for example, software of the type commonly known as BeautifulSoup) and web-crawling frameworks (for example, software of the type commonly known as Scrapy) to retrieve external structured data and unstructured data from network sites and remote databases. The server stores raw data in a temporary storage area in a hierarchical format such as a directory and file hierarchy or a key-value store.

The server uses a language processing module that employs natural language processing libraries (for example, software of the type commonly known as NLTK and spaCy). The server inputs text segments from news articles, press releases, and industry reports and converts them into internal token sequences using tokenization algorithms. The server then applies part-of-speech tagging using a statistical tagger, such as a conditional random field or a recurrent neural network. The server further applies named entity recognition models that are implemented as multi-layer neural networks with word-embedding layers, one or more bidirectional recurrent layers, and a final classification layer. The server outputs entity labels for organization names, locations, financial concepts, and risk expressions and stores them as annotations linked to text offsets.

The server uses a sentiment analysis sub-module that applies a neural network classifier trained with an objective function such as categorical cross-entropy. The server uses embeddings derived from word, subword, or contextual encoders as input features. The server classifies each text segment into sentiment categories (for example, positive, neutral, negative) and assigns a confidence value. The server attaches these sentiment labels as attributes to document records.

The server uses a statistical computation module implemented with data-frame processing libraries (for example, software of the type commonly known as Pandas and NumPy). The server converts structured data, including financial time series and key performance indicators, into arrays and data frames indexed by entity identifiers and time stamps. The server applies numerical operations such as aggregation, normalization, scaling, and missing-value imputation. The server computes derived indicators including profit margins, leverage ratios, volatility metrics, and relative performance values against sector averages. The server stores these derived indicators as features in a feature matrix.

The server constructs a unified feature set by merging text-derived features and numerical indicators. The server represents each decision target or scenario as a feature vector comprising numerical values such as ratios, growth rates, sentiment scores, and frequency counts of specific topics or risk terms. The server stores the feature vectors in a matrix or tensor structure compatible with downstream simulation models. This structure enables reuse of intermediate computations across different simulations, thereby reducing redundant execution of language and numerical processing.

The server implements a simulation module that can use probabilistic models and numerical analysis models. In one embodiment, the server uses a Monte Carlo simulation engine implemented in Python or interfaced to a numerical computation environment of the type commonly known as R or MATLAB. The server parameterizes probability distributions for uncertain inputs, such as revenue growth, cost synergies, and market volatility, using the unified feature set. The server then generates random samples from these distributions and computes outcome metrics such as net present value and success probability. The server stores the resulting distributions in arrays and computes summary statistics such as means, standard deviations, and percentile values.

The server optionally uses parametric or non-parametric models, including regression models and tree-based ensemble models, to map feature vectors to predicted success probabilities and risk scores. The server trains these models offline using supervised learning on historical labeled data and applies them online for new scenarios. During training, the server uses loss functions such as mean squared error or cross-entropy and updates model parameters using optimization algorithms such as stochastic gradient descent or adaptive gradient methods. The terminal captures image data and audio data from the user during interaction. The terminal uses a computer vision library of the type commonly known as OpenCV to detect a face region in each frame and to extract facial landmarks such as eye corners, eyebrow positions, and mouth shape. The terminal uses a locally stored or remote convolutional neural network classifier to encode the face into a feature vector and to classify an emotion category such as joy, neutrality, or anxiety. The terminal also computes acoustic features from audio data, such as pitch, amplitude, and spectral characteristics, and may supply these to a speech-based emotion classifier. The terminal combines visual and acoustic emotion scores into an emotion label and associated confidence level.

The server receives emotion labels and confidence levels from the terminal. The server maps the emotion labels to control values that modify simulation parameters. For example, if the user is detected as anxious, the server reduces the variance of optimistic assumptions and increases the weight of conservative scenarios. If the user is detected as excited, the server may expand the range of aggressive scenarios and increase the emphasis on upside outcomes. The server records, for each scenario executed, the corresponding emotion context, such as “excited-high-risk” or “cautious-low-risk”.

The server uses a prompt-generation module that constructs prompt sentences for a generative AI model. The server accesses the unified feature set, simulation results, and emotion labels and embeds key metrics into the prompt sentences. The server may use template-based rules, where placeholders for numeric values and qualitative descriptors are filled based on computed metrics and emotion state. The server may further use rule-based logic that selects between different prompt styles depending on emotion labels and decision target types. These rules are stored in a rule base and can be updated by the history-analysis module.

The server interfaces to a generative AI model hosted as a remote service or locally, for example a large language model parameterized with a transformer architecture. The generative AI model may include multiple self-attention layers, feed-forward networks, and layer-normalization components with parameters trained on text corpora. The server provides a prompt sentence as input and receives output tokens representing text sequences. The server does not allow the generative AI model to directly access raw external data sources; instead, the server strictly mediates the flow of summarized, structured information via the prompt sentence and optional structured context.

The server uses specific prompt sentence examples to control the generative AI model. For instance, the server may construct and transmit the following prompt sentence: “Based on the following simulation results for a planned acquisition of Fintech Company A, including a 72% success probability, moderate downside risk, and a worst-case net present value of minus ten million units of currency in the bottom ten percent of scenarios, and given that the user is currently excited and open to some risk, please summarize the main risks and opportunities and propose three strategy options: one conservative, one balanced, and one aggressive.”

The server may also generate prompt sentences such as:
“Please simulate the risk and success probability of acquiring Fintech Company A and provide a concise explanation suitable for a cautious decision-maker.”
“Simulate market reaction to our new product announcement and generate a strategy that reflects my current cautious mood.”
“Propose three low-risk, high-growth payment partners based on current business trends and take into account that the user is anxious about downside risk.”

The server receives generated text from the generative AI model and integrates it with simulation results. The server performs post-processing such as segmentation into sections, removal of inconsistent values, or addition of headings. The server then uses a visualization and document-generation module to produce graphical and textual outputs. The server uses visualization libraries of the type commonly known as Matplotlib to render charts and plots representing distributions of net present values, scenario comparisons, and risk profiles. The server exports these charts as image data and embeds them in document structures.

The server constructs document data such as reports in a typesetting language such as LaTeX and slide decks using presentation application programming interfaces. The server inserts generated text, charts, and tables into predefined templates. The server may export the result as a portable document format file or a presentation file. The server also constructs material data for interactive dashboards as structured data containing metrics, labels, and references to image resources.

The terminal receives dashboard data and document links and renders interfaces using a framework such as a web application framework or a native user interface toolkit. The terminal displays key metrics in panels, shows charts as images, and provides text summaries in expandable sections. The terminal adjusts the layout based on emotion labels, for example by emphasizing risk-mitigation sections for anxious users and growth-opportunity sections for excited users.

The server records history data for each interaction. The server logs prompt sentences, emotion labels, simulation parameter settings, simulation results, and generative AI outputs with timestamps and identifiers. The server periodically analyzes this history using statistical modules and language processing modules. The server computes metrics such as correlation between emotion states and requested follow-up simulations, frequency of scenario types that lead to stable or improved emotion states, and patterns in prompt sentences that yield concise or overly long outputs.

The server updates prompt-generation rules and default simulation settings based on history-analysis results. For example, if the history shows that certain prompt constructions consistently produce shorter, more readable outputs for specific user profiles, the server adjusts the templates to favor those constructions. If the history shows that certain simulation parameter ranges lead to more discriminative scenarios with less computational overhead, the server updates default parameter ranges to reduce computation time without loss of useful variance.

The system provides technical effects that go beyond mere automation of human decision-making. The server reduces redundant computations by reusing unified feature sets across multiple simulations, thereby lowering processor load and memory access overhead. The server dynamically adjusts simulation parameters based on emotion labels, which restricts or focuses the scenario space and reduces unnecessary execution of simulations that are mismatched to the user's state. This adaptive behavior results in improved computation efficiency and faster response times.

The integration of emotion-aware parameter control with simulation and prompt generation also improves communication efficiency between the server and the generative AI model. By encoding detailed simulation metrics and emotion context into prompt sentences according to explicit rules, the server reduces the need for multiple iterative queries, which lowers network traffic and processing time on both sides. This structure improves the quality and relevance of the generated content because the generative AI model receives structured, context-rich instructions aligned with the internal analytical state.

The system further improves data management by maintaining explicit mappings between raw data, features, scenarios, prompt sentences, and generated outputs in the history data.

This mapping enables traceable reproducibility of results and facilitates later optimization of pipeline components. Because the server centrally manages these relationships and updates models and rules based on accumulated evidence, the system continuously improves its internal processing behavior in a way that is not achievable by static manual workflows.

The server can implement alternative neural network architectures for the emotion recognition and language processing components. In one variation, the terminal uses a convolutional neural network with residual connections for facial expression classification and a recurrent neural network with attention mechanisms for speech emotion recognition. In another variation, the server uses a transformer-based encoder for document-level sentiment analysis and topic detection, combining global attention over tokens with position encodings. Training for these models may employ data augmentation techniques such as random cropping, horizontal flipping of facial images, or noise injection into audio signals to improve robustness. Loss functions such as cross-entropy or focal loss may be used to handle class imbalance in emotion categories.

The server may also support alternative simulation engines, such as a Bayesian network-based model or a scenario-tree optimization model. In such embodiments, the unified feature set provides priors or scenario weights, and the emotion-conditioned parameters adjust the structure of the scenario tree or the risk-aversion coefficients in an optimization objective. The technical effect remains an improvement in computational efficiency and adaptivity, because the system avoids exploring scenario branches that are inconsistent with the user's emotion state and decision target profile.

The system is not limited to a particular network topology or physical deployment. The server may be implemented as a single physical machine, a cluster of machines, or a virtualized environment in a distributed computing infrastructure. The terminal may be a handheld communication device, a desktop workstation, or a dedicated console. In all these configurations, the defined modules and data flows remain applicable, and the processor behavior as claimed is realized by executing appropriate instructions stored in the memory. By tightly coupling multi-source data acquisition, unified feature generation, emotion-aware simulation control, structured prompt sentence generation for a generative AI model, and adaptive visualization and document creation, the system improves the operation of computer technology itself. The server reduces computational redundancy, enhances the precision of simulation outputs through model parameter control based on real-time signals, and optimizes text-generation interactions through data-driven prompt refinement. These technical improvements lead to faster processing, reduced resource consumption, more accurate and relevant outputs, and an improved human-computer interface that responds to measurable user states in a manner not achievable with conventional, static business-logic automation.

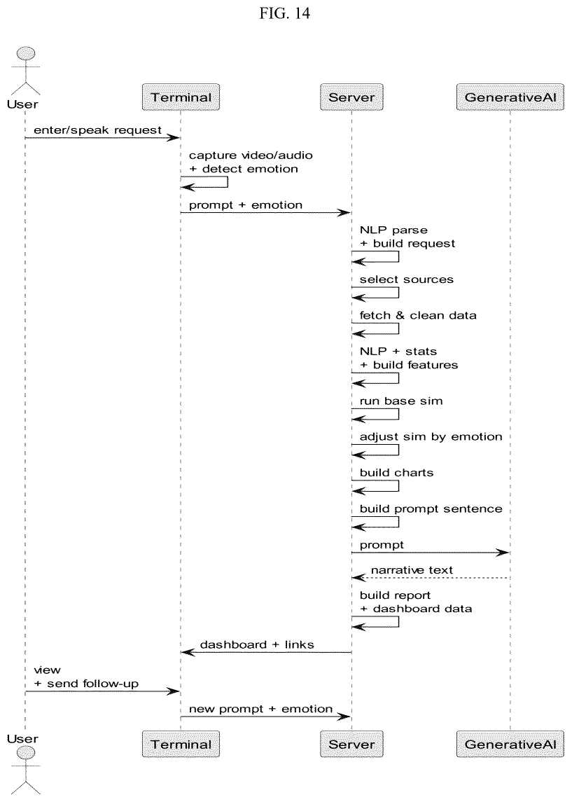

The following describes the processing flow using FIG. 14.

### Step 1:

The user provides an analysis request to the system. The user inputs a prompt sentence in natural language, for example, “Please simulate the risk and success probability of acquiring Fintech Company A,” by typing on the terminal or speaking into the microphone.

Input: Raw user interaction (keystrokes or speech audio).

Output: A textual prompt sentence.

The terminal converts spoken audio into text using a speech recognition service, and the terminal sends the prompt sentence together with user identifiers and a timestamp to the server via a network connection.

### Step 2:

The terminal acquires emotion-related data from the user. The terminal captures image data from the camera and audio data from the microphone while the user is issuing the prompt sentence.

Input: Raw image frames and raw audio waveforms.

Output: An emotion label and an emotion confidence score.

The terminal uses a computer vision library to detect the user's face and extract facial landmarks, and uses a neural-network-based classifier to map the landmarks to an emotion category such as “excited,” “neutral,” or “anxious.” The terminal simultaneously extracts acoustic features from the audio and optionally combines them with visual features. The terminal computes a final emotion label and confidence, and transmits these values to the server together with the prompt sentence.

### Step 3:

The server interprets the received prompt sentence. The server receives the prompt sentence and emotion label from the terminal and applies natural language processing to the text.

Input: Prompt sentence text and associated metadata.

Output: A structured request object indicating intent, entities, and parameters.

The server uses tokenization, part-of-speech tagging, and named entity recognition to identify company names, transaction types, time periods, and constraints. The server then applies an intent classification model to categorize the request, for example as “M&A simulation,” “partner selection,” or “market reaction analysis.” The server stores the extracted elements in a structured request object that is used to configure downstream processing.

### Step 4:

The server determines appropriate data sources. The server reads the structured request and selects relevant external information sources such as financial data providers and industry news feeds.

Input: Structured request object.

Output: A list of target endpoints and query configurations.

The server consults a configuration repository that maps industries and entity identifiers to specific network resources, and constructs uniform resource locators, application programming interface queries, and scraping rules. The server produces a data-source plan describing which URLs and endpoints to query and which parsing instructions to use.

### Step 5:

The server collects raw data from external sources. The server executes data acquisition routines using web-scraping and API clients.

Input: Data-source plan (URLs, APIs, scraping rules).

Output: Raw structured and unstructured data records.

The server sends HTTP requests to external services, receives HTML, JSON, or other response formats, and stores the responses. The server parses HTML with an HTML parser, extracts table elements and article bodies, and captures JSON payloads as-is. The server saves the retrieved contents in temporary storage with identifiers associated with the target entities.

### Step 6:

The server normalizes and structures the collected data. The server converts heterogeneous raw records into internal tabular and textual representations.

Input: Raw HTML, JSON, and text documents.

Output: Cleaned data frames for numerical data and normalized text documents.

The server uses a data-frame library to parse numeric fields, convert localized number formats into standard numeric values, and align time series to a uniform calendar. The server labels each record with entity and time keys, removes duplicates, and resolves inconsistent units. The server also extracts plain text from HTML for subsequent language processing and stores it as normalized text records.

### Step 7:

The server performs language analysis on textual information. The server processes normalized text documents that include news, press releases, and reports.

Input: Normalized text records.

Output: Annotated text objects with entities, sentiment scores, and topic features.

The server tokenizes each document into words or subwords, removes stop words, and applies named entity recognition to identify corporations, products, markets, and regulatory bodies. The server then applies a sentiment classifier to assign a sentiment score to each document and may apply a topic modeling or classification algorithm to derive topic distributions. The server stores these annotations as additional fields associated with each text record.

### Step 8:

The server computes quantitative indicators from structured data. The server derives financial and statistical features from cleaned numerical data.

Input: Data frames of financial time series and key indicators.

Output: Feature vectors with derived metrics per entity and period.

The server calculates ratios such as revenue growth, profitability margins, leverage ratios, and volatility measures using arithmetic operations, aggregation functions, and rolling-window calculations. The server joins entity-specific data with industry benchmarks to compute relative performance metrics. The server encodes these metrics in feature vectors stored in a feature matrix keyed by entity and scenario.

### Step 9:

The server integrates text-derived and numeric features into a unified feature set. The server merges sentiment and topic features with quantitative indicators.

Input: Annotated text features and numeric feature vectors.

Output: Unified feature vectors representing each decision target and scenario.

The server aggregates sentiment scores, counts risk-related terms, and summarizes topic distributions over a selected time window, then concatenates these values with numeric indicators into a single vector per entity. The server normalizes or scales different feature components to comparable ranges and stores the result in a matrix structure for simulation input.

### Step 10:

The server runs the base simulation using the unified feature set. The server configures and executes probabilistic or numerical models to evaluate outcomes.

Input: Unified feature vectors and simulation configuration parameters.

Output: Simulated outcome distributions and scenario statistics.

The server maps feature vectors to parameters of probability distributions for uncertain variables such as growth rates and synergy values. The server then performs Monte Carlo sampling or other simulation methods to generate many possible future outcome paths. For each path, the server computes metrics such as net present value and classifies the outcome as success or failure according to a defined threshold. The server aggregates all sampled results to produce distributions and summary statistics for each scenario.

### Step 11:

The server adapts simulation parameters based on the emotion label. The server uses the emotion label from the terminal to adjust risk preferences and scenario selection.

Input: Base simulation configuration, unified feature set, and emotion label.

Output: Emotion-adjusted simulation configuration and updated outcome statistics.

The server applies rule-based mappings from emotion categories to parameter changes, for example decreasing the range of aggressive assumptions for an anxious user or enabling more optimistic variants for an excited user. The server either re-runs simulations with modified parameters or reweights existing scenario outcomes according to emotion-dependent weights. The server computes new summary statistics for emotion-adjusted scenarios and tags each result with the emotion context.

### Step 12:

The server generates visualization data for simulation results. The server converts numerical distributions and scenario statistics into graphical forms.

Input: Base and emotion-adjusted simulation statistics.

Output: Plot images or plotting specifications.

The server selects appropriate chart types such as histograms, cumulative distribution plots, and scenario comparison bar charts. The server constructs plotting commands, renders them using a visualization library, and generates image files representing the results. The server associates descriptive labels and legends with each chart and stores references to these images for later document and dashboard assembly.

### Step 13:

The server constructs a prompt sentence for the generative AI model. The server encodes simulation results and emotion context in natural language instructions.

Input: Unified feature set summary, simulation statistics, and emotion label.

Output: A prompt sentence tailored to the current analysis and user state.

The server applies a set of templates and rules that select which metrics to mention, how to describe risk and opportunity, and how to reference the user's emotion. The server fills placeholders in a template with numerical values such as success probability and worst-case net present value, and with qualitative descriptors based on sentiment and emotion. The server outputs a prompt sentence such as: “The base simulation shows a 72% success probability and moderate downside risk, and the user is excited and open to some risk; please summarize the main risks and opportunities and propose three strategy options: one conservative, one balanced, and one aggressive.”

### Step 14:

The server obtains narrative content from the generative AI model. The server transmits the constructed prompt sentence to the generative AI model via an application programming interface.

Input: Prompt sentence and optional structured context.

Output: Generated text containing explanation, analysis, and recommendations.

The server sends the prompt to the generative AI endpoint, receives a sequence of tokens representing the generated narrative, and converts the tokens into text. The server checks the generated content for basic consistency with expected ranges of values and splits the content into sections such as overview, risks, opportunities, and recommendations. The server stores the processed text for integration with other outputs.

### Step 15:

The server assembles document data and material data. The server combines charts, tables, and generated narrative into structured report and presentation formats.

Input: Visualization images, simulation tables, and generated text.

Output: Document data structures for reports and presentation materials.

The server inserts charts and tables into predefined report templates, positions generated text in corresponding sections, and generates a document object representing the assembled report. The server similarly populates slide templates with key charts and bullet points derived from the generated narrative. The server then exports the completed report and presentation as files or stores their structure in a database.

### Step 16:

The server builds a dashboard payload for the terminal. The server prepares a compact representation of key results suitable for interactive display.

Input: Simulation statistics, visualization references, and selected narrative excerpts.

Output: A structured payload for real-time dashboard rendering.

The server selects core metrics such as success probability, risk indicators, and headline recommendations, and pairs them with references to the most informative charts. The server extracts concise paragraphs from the generated narrative that match the user's emotion context and packages all of this information in a structured format, including fields for layout hints such as display order and emphasis levels based on the emotion label.

### Step 17:

The terminal renders the interactive dashboard. The terminal receives the dashboard payload from the server and uses its user interface layer to construct on-screen elements.

Input: Structured dashboard payload and associated image data.

Output: An interactive screen displaying metrics, charts, and narrative text.

The terminal arranges panels for key numbers, draws chart images in designated areas, and shows explanatory text in scrollable regions. The terminal applies emphasis according to the provided layout hints, for example highlighting conservative scenarios and risk warnings for an anxious user. The terminal allows the user to tap or click on scenarios to expand details or to request alternative views.

### Step 18:

The server provides access to full reports and presentation materials. The server makes the assembled document and slide files available to the user.

Input: Document data structures and file generation configuration.

Output: Downloadable report and presentation files.

The server stores the generated files in a file repository, creates secure access links or identifiers, and sends references to the terminal. The terminal displays controls such as “Open full M&A evaluation report,” and when the user selects a control, the terminal downloads and displays the document via a viewer application.

### Step 19:

The user reviews outputs and optionally issues follow-up requests. The user examines the dashboard and documents and may decide to refine assumptions or explore alternatives.

Input: Visualized results, narrative explanations, and report contents.

Output: New prompt sentences and interaction traces.

The user uses the terminal to submit new prompts such as “Re-simulate with a lower purchase price” or “Compare Fintech Company A with Fintech Company B.” The terminal repeats emotion capture for these interactions and forwards the new prompts and emotion labels to the server, initiating another iteration of the processing flow.

### Step 20:

The server logs interaction history and updates internal rules. The server records all key artifacts and analyzes them for future optimization.

Input: Prompt sentences, emotion labels, simulation configurations, simulation outcomes, and generative AI outputs.

Output: Updated prompt-generation rules and simulation default settings.

The server writes each interaction to a history store, then periodically reads accumulated logs and applies statistical and language analysis to detect patterns, such as which prompt constructions yield concise, accurate outputs and which simulation parameter ranges provide discriminative yet efficient scenario sets. The server modifies rule tables and default configurations accordingly, so that subsequent executions of the program use improved prompts and simulation settings that enhance computational efficiency and output relevance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

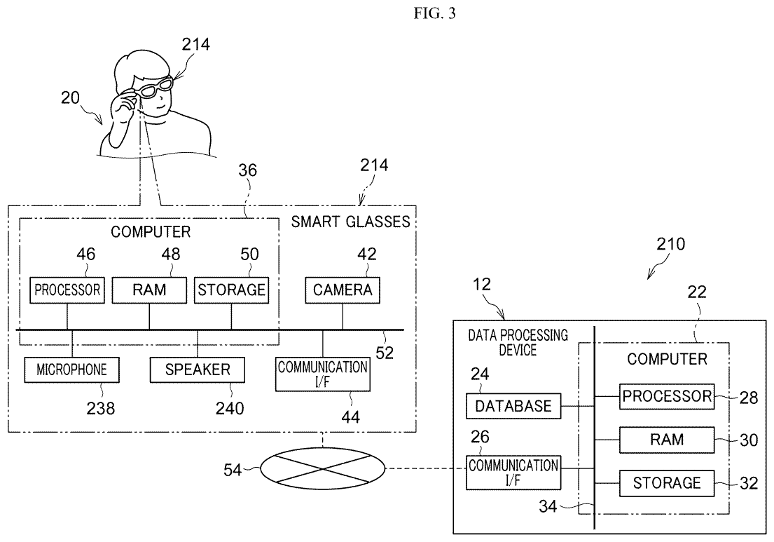

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

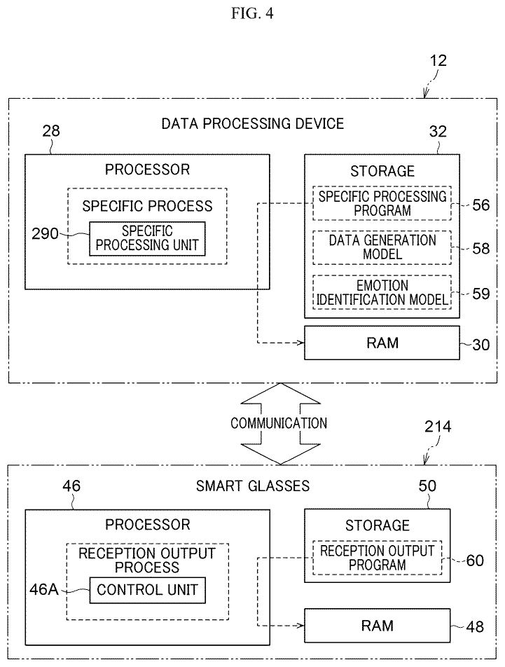

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

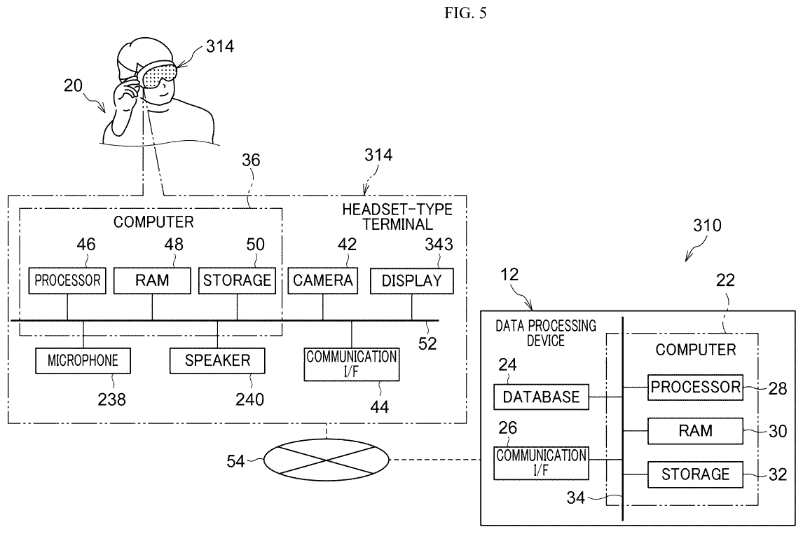

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

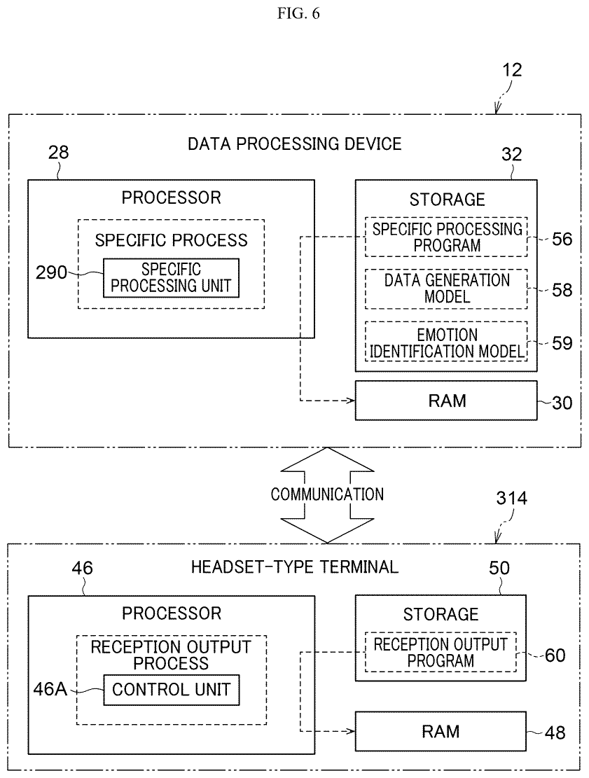

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

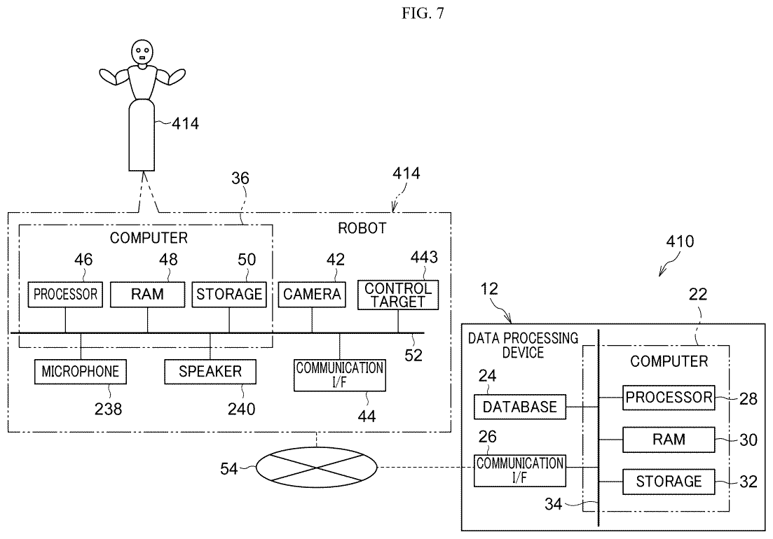

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

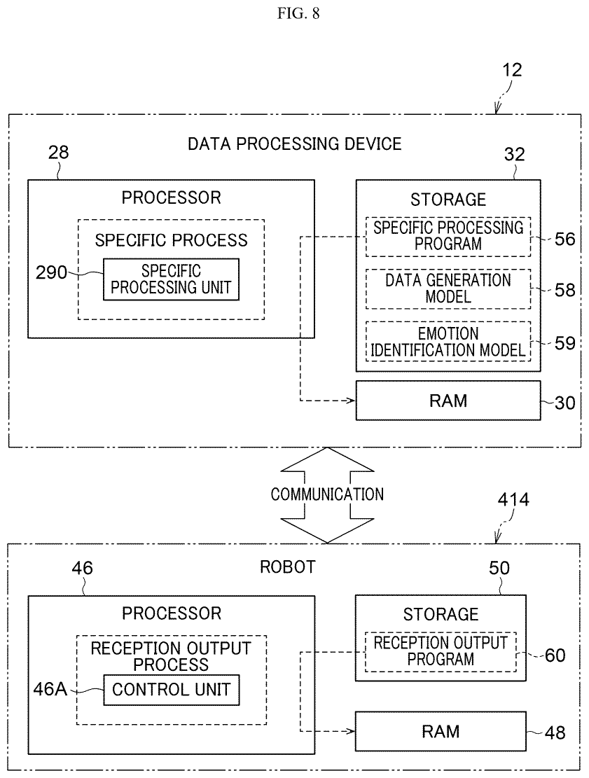

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

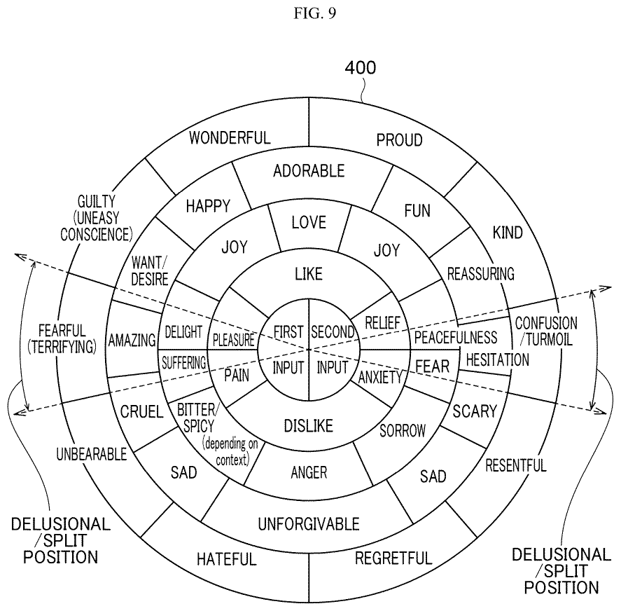

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

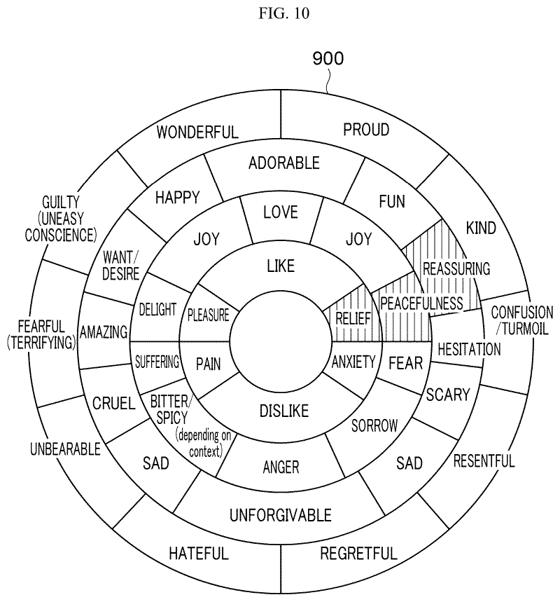

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire information regarding events from external information sources via a network and store the acquired information as structured data,
perform language analysis processing including morphological analysis, part-of-speech tagging, emotion estimation, and topic classification on natural language data included in the structured data, and accumulate analysis results as analysis data,
generate time-series indicators and feature quantities from the analysis data, use a statistical learning model or a machine learning model to perform prediction processing or classification processing based on the feature quantities to calculate a plurality of scenarios regarding future events, and generate simulation result data including predicted values and evaluation indicators corresponding to the respective scenarios,
generate a prompt sentence, based on the simulation result data and condition information associated with the simulation result data, the prompt sentence defining an objective, an output format, an explanation structure, and elements to be emphasized, and configure prompt data for input to a generative AI model by adding the simulation result data to the prompt sentence,
input the prompt data to the generative AI model to cause the generative AI model to generate an explanatory text in natural language, and convert the explanatory text into output format data as report data or presentation data and store the output format data, and
select, in accordance with a request content and a state information of a user received from a terminal device, report data or presentation data to be displayed from among the output format data, and provide the selected report data or presentation data to the terminal device.

### (Supplementary 2)

The system according to supplementary 1,
wherein the processor is configured to
generate the prompt sentence by including, in the prompt sentence, a natural language instruction sentence indicating the request content of the user input from the terminal device, and by structuring a plurality of scenarios, main evaluation indicators, and comparison targets extracted from the simulation result data to present the plurality of scenarios, the main evaluation indicators, and the comparison targets to the generative AI model, thereby instructing the generative AI model to create an explanatory text for decision-making support.

### (Supplementary 3)

The system according to supplementary 1,
wherein the processor is configured to
estimate, for each scenario having a plurality of premise conditions, future indicator values using the analysis data and large-scale data acquired from an external source to generate the simulation result data, and generate the prompt sentence including instruction content for causing the generative AI model to generate, for each scenario, a contingent proposal or an alternative proposal.

### Application Example 1

### (Supplementary 1)

A system comprising a processor,
wherein the processor is configured to
obtain, via a communication network and an information storage device, information related to organizations and industrial fields, information related to economic tendencies, publicly disclosed information, and news information, and to perform preprocessing on the obtained information by using character-information processing technology to generate feature data, calculate temporal transitions for extracted terms and topics, and extract features related to actions of competitive entities,
generate a prompt sentence, on the basis of the feature data, the temporal transitions, and the features related to the actions of the competitive entities, for instructing a generative AI model to create a plurality of proposal plans related to advertising activities, acquire the plurality of proposal plans related to the advertising activities from the generative AI model, and store the plurality of proposal plans as structured data,
input information included in the structured data, the information including media categories, target groups, appeal contents, and expenditure amounts, into a statistical learning model, predict index values for each of the plurality of proposal plans, evaluate the plurality of proposal plans under predetermined constraint conditions, and specify prioritized advertising activity plans,
generate visualization data for figure generation by using as input the temporal transitions, the index values, and the prioritized advertising activity plans, create report materials including the visualization data, and transmit the report materials to an external terminal, and
re-execute the evaluation and the prioritization on the basis of change contents of the advertising activity plans received from the external terminal, update results of the evaluation and the prioritization, and present the updated results to the external terminal.

### (Supplementary 2)

The system according to supplementary 1,
wherein the processor is configured to
accept, as an instruction to the generative AI model, a prompt sentence input from the external terminal, acquire, from the generative AI model, a new proposal plan related to an advertising activity on the basis of the prompt sentence, evaluate and prioritize the new proposal plan by using the respective functions according to supplementary 1, and present the evaluated and prioritized new proposal plan to the external terminal.

### (Supplementary 3)

The system according to supplementary 1,
wherein the processor is configured to
automatically generate an explanatory text summarizing the temporal transitions, the features related to the actions of the competitive entities, and the prioritized advertising activity plans when creating the report materials, output the report materials including the explanatory text, and support decision-making so that a proposer can concentrate on content review and recommendation work.

### Example 2

### (Supplementary 1)

A system comprising a processor,
wherein the processor is configured to
receive, via a communication network, identification information of information resources to be acquired, acquire structured or unstructured information from public information sources by using standardized communication protocols, and store the acquired information in a storage device,
perform preprocessing on the information stored in the storage device, the preprocessing including data conversion processing, missing-value processing, unit-conversion processing, and time-series alignment processing, and generate analysis-target data for statistical processing,
execute statistical-analysis processing and numerical-analysis processing on the analysis-target data, calculate performance-evaluation indices including growth-trend indices,
profitability indices, risk indices, and correlation indices, and construct a probabilistic model or a regression model based on the performance-evaluation indices,
execute, by using the probabilistic model or the regression model and the analysis-target data, iterative computation based on random-number generation processing to generate a plurality of future scenarios, and calculate an evaluation value for each scenario to generate simulation-result data including distribution information, success probability, expected value, and downside-risk indices,
generate, from the simulation-result data and the performance-evaluation indices, table-format data, image data, and summary-text data, and generate report-document data by placing the table-format data, the image data, and the summary-text data into a document-generation template, and output the report-document data in an electronic-document format,
generate, by using analysis-result data including the performance-evaluation indices and the simulation-result data, a prompt sentence that instructs a generative language-processing device to generate an explanatory sentence, a summary sentence, or a proposal sentence for decision support, and integrate generated text obtained from the generative language-processing device into the report-document data, and
transmit, in response to a request from a user terminal, the report-document data in the electronic-document format, and provide the report-document data so that a user can make a decision based on the report-document data.

### (Supplementary 2)

The system according to supplementary 1,
wherein the processor is configured to
extract at least part of a success probability, an expected-return index, and a risk index included in the simulation-result data, generate a plurality of types of prompt sentences corresponding respectively to a summary explanation for a decision maker, a risk-analysis explanation, and a recommendation explanation, transmit the plurality of types of prompt sentences sequentially or in parallel to the generative language-processing device to acquire a plurality of types of generated text, and place the plurality of types of generated text in sections or subsections of the report-document data corresponding to the respective types so that a user who performs high value-added judgment operations can concentrate on content review and recommendation creation.

### (Supplementary 3)

The system according to supplementary 1,
wherein the processor is configured to
select features from the analysis-target data and the simulation-result data in accordance with a plurality of types of decision targets including transaction decisions, collaboration decisions, and organizational-restructuring decisions, generate a prompt sentence that instructs the generative language-processing device to generate serendipitous proposals, alternative options, and scenario comparisons based on the selected features, and include the serendipitous proposals, the alternative options, and the scenario comparisons acquired from the generative language-processing device in the report-document data so as to promote innovative decision making based on analysis results of large-scale information.

### Application Example 2

### (Supplementary 1)

A system comprising a processor,
wherein the processor is configured to
acquire, via a communication network, structured data and unstructured data related to a business target from external information sources, apply language processing algorithms to acquired text data to perform tokenization, part-of-speech tagging, entity extraction, sentiment evaluation, and topic extraction, apply statistical computation algorithms to numerical data to perform indicator calculation, missing-value processing, and feature generation, and thereby generate a set of features for simulation,
execute, based on the set of features, a future prediction simulation using a probabilistic model or a numerical analysis model, calculate distributions of success probability, loss risk, cost-effectiveness, and evaluation indicators, generate summary values for a plurality of scenarios corresponding to the distributions, and generate visualization data of simulation results,
perform feature extraction and classification processing on image data and audio data obtained from a user terminal, calculate an emotion label and a confidence level indicating an emotional state of a user, and adjust model parameters or scenario selection of the simulation in accordance with the emotion label,
automatically generate a prompt sentence for instructing a generative AI model to generate analytical content and recommendation content for decision support, based on the set of features, the simulation results, and the emotion label, and construct document data or material data by associating explanation text, summary text, or recommendation content received from the generative AI model with the visualization data,
transmit the document data or the material data and the visualization data to the user terminal with a display order or emphasis degree controlled in accordance with the emotion label, and present the data through an interactive screen configuration, and
record the prompt sentence, the emotion label, the simulation results, and outputs of the generative AI model as history data, and analyze the history data to update generation rules of the prompt sentence and setting values of the simulation.

### (Supplementary 2)

The system according to supplementary 1,
wherein the processor is configured to
generate the prompt sentence transmitted to the generative AI model as a sentence including information for dynamically controlling a summarization granularity, an explanation difficulty level, and a number of options, in accordance with the simulation results and the emotion label, such that a proposer can concentrate on high value-added judgment processing including content review and recommendation.

### (Supplementary 3)

The system according to supplementary 1,
wherein the processor is configured to
apply a simulation model and generation processing of the prompt sentence commonly to a plurality of decision targets including at least transaction condition determination, partner selection, organizational restructuring, capital alliance, and business acquisition, and automatically generate a prompt sentence for instructing the generative AI model to present incidental alternative proposals or new scenarios, based on accumulated history data, to promote innovative decision making.

What is claimed is:

1. A system comprising:
circuitry configured to:
receive, via a communication interface coupled to a packet-switched network, event-related data from one or more external data sources and store the event-related data as structured data in a memory;
perform language analysis processing on natural language data included in the structured data, the language analysis processing comprising morphological analysis, part-of-speech tagging, sentiment classification, and topic classification, and accumulate resulting analysis data in the memory;
generate time-series indicators and feature quantities from the analysis data, input the feature quantities to a machine learning model to perform prediction processing or classification processing, and generate simulation result data comprising predicted values and evaluation indicators corresponding to a plurality of scenarios;
generate prompt data for input to a generative AI model by constructing a prompt sentence based on the simulation result data and condition information, the prompt sentence defining an objective, an output format, an explanation structure, and elements to be emphasized, and by associating the simulation result data with the prompt sentence; and
input the prompt data to the generative AI model to cause the generative AI model to generate an explanatory text, convert the explanatory text into output format data, and store the output format data in the memory.

2. The system according to claim 1, wherein the circuitry is configured to
receive request content and state information of a user from a terminal device via the communication interface, select output format data from among a plurality of stored output format data based on the request content and the state information, and transmit the selected output format data to the terminal device.

3. The system according to claim 2, wherein the circuitry is configured to
determine an emotion label based on the state information, and select the output format data corresponding to a presentation style adapted to the emotion label.

4. The system according to claim 3, wherein the circuitry is configured to
generate the prompt sentence by including a natural language instruction sentence indicating the request content of the user in the prompt sentence and by structuring the plurality of scenarios, main evaluation indicators, and comparison targets extracted from the simulation result data to present the structured content to the generative AI model.

5. The system according to claim 4, wherein the circuitry is configured to
include, in the prompt sentence, instruction content that controls a summarization granularity, an explanation difficulty level, and a number of options in accordance with the simulation result data and the emotion label.

6. The system according to claim 1, wherein the circuitry is configured to
estimate future indicator values for each scenario having a plurality of premise conditions using the analysis data and supplementary data acquired from an external source, and generate the prompt sentence comprising instruction content that causes the generative AI model to generate, for each scenario, a contingent proposal or an alternative proposal.

7. The system according to claim 1, wherein the circuitry is configured to
apply the simulation result data and the prompt generation processing to a plurality of decision targets comprising at least two of transaction condition determination, partner selection, organizational restructuring, capital alliance, and business acquisition, and generate a prompt sentence that instructs the generative AI model to present alternative proposals or new scenarios based on accumulated history data.

8. The system according to claim 1, wherein the machine learning model comprises a statistical learning model or a neural network model trained to perform at least one of regression, classification, or anomaly detection on the feature quantities.

9. The system according to claim 1, wherein the language analysis processing further comprises named entity recognition applied to the natural language data, and wherein the circuitry is configured to store recognized entity data as part of the analysis data.

10. The system according to claim 1, wherein the circuitry is configured to
accumulate the analysis data as time-series data associated with timestamps, and generate the time-series indicators by applying sliding window aggregation or trend decomposition to the time-series data.

11. The system according to claim 1, wherein the output format data comprises report data or presentation data generated by converting the explanatory text according to a predetermined output schema.

12. The system according to claim 1, wherein the circuitry is configured to
periodically acquire updated event-related data from the external data sources, update the structured data in the memory, and trigger re-execution of the language analysis processing and simulation result data generation when a change in the updated structured data exceeds a predetermined threshold.

13. The system according to claim 1, wherein the structured data comprises at least two of organizational information, industry trend data, published announcements, and news data acquired via the communication interface.

14. The system according to claim 13, wherein the circuitry is configured to
normalize the organizational information and the industry trend data by applying entity resolution to align records referring to the same entity across the at least two data types.

15. The system according to claim 1, wherein the condition information comprises at least one of a target indicator range, a time horizon, or a constraint parameter associated with the simulation.

16. The system according to claim 1, wherein the circuitry is configured to
log an execution record comprising the input prompt data and the corresponding output format data for each invocation of the generative AI model, and store the execution record in the memory for audit and reproducibility.

17. The system according to claim 16, wherein the circuitry is configured to
compare a newly generated explanatory text against a prior explanatory text stored in the execution record, compute a similarity score, and flag the newly generated explanatory text for review when the similarity score falls below a predetermined threshold.

18. A system comprising:
circuitry configured to:
acquire structured data from external data sources via a communication interface and accumulate language analysis results comprising sentiment classification data and topic classification data derived from natural language data in the structured data;
input feature quantities derived from the language analysis results to a machine learning model and generate simulation result data comprising predicted values and evaluation indicators for a plurality of scenarios;
construct prompt data by generating a prompt sentence that incorporates the simulation result data and defines an output format and explanation structure, and input the prompt data to a generative AI model to generate explanatory text; and
convert the explanatory text into output format data and select, based on state information of a user received from a terminal device, output format data adapted to the state information for transmission to the terminal device via the communication interface.

19. The system according to claim 18, wherein the circuitry is configured to
determine an emotion label from the state information and adjust a summarization granularity and explanation difficulty level of the prompt sentence based on the emotion label.

20. A method comprising:
receiving, via a communication interface coupled to a packet-switched network, event-related data from one or more external data sources and storing the event-related data as structured data in a memory;
performing language analysis processing on natural language data included in the structured data, the language analysis processing comprising morphological analysis, part-of-speech tagging, sentiment classification, and topic classification, and accumulating resulting analysis data in the memory;
generating time-series indicators and feature quantities from the analysis data, inputting the feature quantities to a machine learning model to perform prediction processing or classification processing, and generating simulation result data comprising predicted values and evaluation indicators corresponding to a plurality of scenarios;
generating prompt data for input to a generative AI model by constructing a prompt sentence based on the simulation result data and condition information, the prompt sentence defining an objective, an output format, an explanation structure, and elements to be emphasized, and associating the simulation result data with the prompt sentence; and
inputting the prompt data to the generative AI model to cause the generative AI model to generate an explanatory text, converting the explanatory text into output format data, and storing the output format data in the memory.
